(19) United States
(12) Patent Application Publication
(10) Pub. No.: US 2026/0084379 A1
(43) Pub. Date: Mar. 26, 2026

(54) STOCHASTIC DISCRETIZATION OF OBJECT SLICES FOR ADDITIVE MANUFACTURING

(71) Applicant: Align Technology, Inc., San Jose, CA (US)

(72) Inventors: Xirui Peng, Apex, NC (US); Yuxiang Wang, Newark, CA (US); Wolfgang Steiger, Vienna (AT); Alexander Hochwallner, Vienna (AT); Viswanath Meenakshisundaram, Santa Clara, CA (US); Peter Dorfinger, Woodside, CA (US); Jun Sato, San Jose, CA (US)

(21) Appl. No.: 19/334,390

(22) Filed: Sep. 19, 2025

Related U.S. Application Data
(60) Provisional application No. 63/697,366, filed on Sep. 20, 2024.

(51) Int. Cl. B29C 64/393; B29C 64/124; B33Y 10/00; B33Y 50/02

(52) U.S. Cl. CPC B29C 64/393; B29C 64/124; B33Y 10/00; B33Y 50/02

(57) ABSTRACT

Methods for additive manufacturing and associated systems are provided. In some embodiments, a method includes receiving a 3D digital representation of an object. The method can include generating a plurality of grayscale slices corresponding to a plurality of 2D cross-sections of the 3D digital representation, where each grayscale slice comprises a plurality of grayscale units. The method can also include generating a plurality of discretized slices based on the plurality of grayscale slices, where each discretized slice comprises a plurality of discretized units, and where each discretized unit is generated by applying a discretizing function to a corresponding grayscale unit of a corresponding grayscale slice. The method can further include outputting instructions for fabricating the object via an additive manufacturing process based on the plurality of discretized slices.

### CROSS-REFERENCE TO RELATED APPLICATION(S)

The present application claims the benefit of priority to U.S. Provisional Patent Application No. 63/697,366, filed Sep. 20, 2024, which is incorporated by reference herein in its entirety.

### TECHNICAL FIELD

The present technology generally relates to manufacturing, and in particular, to stochastic discretization of object slices for additive manufacturing.

### BACKGROUND

Additive manufacturing encompasses a variety of technologies that involve building up 3D objects from multiple layers of material. The design and fabrication process typically involves creating a 3D model of an object, converting the 3D model into a series of slices, then sequentially printing the slices to build up the object in a layer-by-layer manner. The dimensional accuracy of a printed object may be constrained by the capabilities of the additive manufacturing system used to fabricate the object. For instance, the resolution of the additive manufacturing system may be lower than the resolution of the initial 3D model of the object, such that the object geometry is downsampled to a lower resolution during the process of converting the 3D model into slices. The downsampling may cause loss of fidelity of the object geometry, such that the actual geometry of the printed object deviates from the initial object design, which can detrimentally affect the function and properties of the printed object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram illustrating a workflow for designing and fabricating an additively manufactured object, in accordance with embodiments of the present technology.

FIGS. 2A-2C illustrate an example of loss of fidelity that may occur when generating object slices for additive manufacturing.

FIG. 3 is a flow diagram illustrating a method for generating object slices for additive manufacturing, in accordance with embodiments of the present technology.

FIG. 4A illustrates a plurality of grayscale slices generated from a 3D digital representation of an object, in accordance with embodiments of the present technology.

FIG. 4B illustrates a plurality of binary slices generated from the grayscale slices of FIG. 4A, in accordance with embodiments of the present technology.

FIG. 4C illustrates an object geometry produced by an additive manufacturing process based on the binary slices of FIG. 4B, in accordance with embodiments of the present technology.

FIGS. 4D-4G illustrate representative examples of binarizing functions for generating binary slices from grayscale slices, in accordance with embodiments of the present technology.

FIGS. 5A-5H illustrate processes for producing object slices to improve the fidelity of an additively manufactured object, in accordance with embodiments of the present technology.

FIGS. 6A-6D illustrate example object slices for a dental appliance to be fabricated via an additive manufacturing process, in accordance with embodiments of the present technology.

FIGS. 7A-7C illustrate example object slices for an additive manufacturing process, in accordance with embodiments of the present technology.

FIG. 8 illustrates an example of object contours that can be used to identify regions of interest for probabilistic discretization, in accordance with embodiments of the present technology.

FIGS. 9A-9D illustrate the use of binary object slices with sub-optical resolution to achieve variable energy dosages, in accordance with embodiments of the present technology.

FIGS. 10A-10C illustrate the use of binary slices with sub-optical resolution to reduce stair-stepping effects, in accordance with embodiments of the present technology.

FIGS. 11A and 11B illustrate the use of binary slices with sub-optical resolution to produce features below the optical resolution limit, in accordance with embodiments of the present technology.

FIGS. 12A-12C illustrate the use of binary slices with sub-optical resolution to produce gradients in energy distribution and curing, in accordance with embodiments of the present technology.

FIG. 13 illustrates a height map of an object with microscale surface features and a corresponding grayscale slice for additive manufacturing of the object, in accordance with embodiments of the present technology.

FIG. 14 illustrates a binary slice with an overlaid object cross-section, in accordance with embodiments of the present technology.

FIG. 15 is a flow diagram illustrating a method for generating object slices for additive manufacturing, in accordance with embodiments of the present technology.

FIGS. 16A-16C illustrate representative examples of a high resolution slice and lower resolution slices that may be generated from the high resolution slice using various methods, in accordance with embodiments of the present technology.

FIG. 17 is a partially schematic diagram providing a general overview of an additive manufacturing process, in accordance with embodiments of the present technology.

FIG. 18A illustrates a representative example of a tooth repositioning appliance configured in accordance with embodiments of the present technology.

FIG. 18B illustrates a tooth repositioning system including a plurality of appliances, in accordance with embodiments of the present technology.

FIG. 18C illustrates a method of orthodontic treatment using a plurality of appliances, in accordance with embodiments of the present technology.

FIG. 19 illustrates a method for designing an orthodontic appliance, in accordance with embodiments of the present technology.

FIG. 20 illustrates a method for digitally planning an orthodontic treatment and/or design or fabrication of an appliance, in accordance with embodiments of the present technology.

FIG. 21A shows a 3D digital representation of a coupon set for additive manufacturing.

FIGS. 21B and 21C show binary slices for the coupon set of FIG. 21A generated using conventional hard binarization (bottom) and using stochastic discretization (top).

FIG. 21D is a photograph of the coupon set of FIG. 21A after additive manufacturing and post-processing.

FIG. 21E is a photograph of coupons fabricated using traditional slices.

FIG. 21F is a photograph of coupons fabricated using stochastic slices.

FIGS. 21G and 21H are graphs illustrating the surface geometry of coupons fabricated using traditional slices (FIG. 21G) and stochastic slices (FIG. 21H).

FIG. 22A illustrates a coupon design.

FIG. 22B illustrates binary slices for the coupon of FIG. 22A generated using stochastic discretization.

FIG. 22C illustrates tensile testing results for the coupon of FIG. 22A fabricated based on stochastic discretization with various grayscale values.

### DETAILED DESCRIPTION

The present technology relates to methods and systems for additive manufacturing. In some embodiments, for example, a method includes receiving a 3D digital representation of an object. The method can include generating a plurality of grayscale slices corresponding to a plurality of 2D cross-sections of the 3D digital representation, where each grayscale slice comprises a plurality of grayscale units (e.g., grayscale pixels or voxels). The method can also include generating a plurality of binary slices based on the plurality of grayscale slices, where each binary slice comprises a plurality of binary units (e.g., black and white pixels or voxels). Each binary unit can be generated by applying a binarizing function to a corresponding grayscale unit of a corresponding grayscale slice. For example, the binarizing function can be a probabilistic function (e.g., a stochastic function) based on the grayscale value of the grayscale unit. The method can further include outputting instructions for fabricating the object via an additive manufacturing process based on the plurality of binary slices.

As another example, a method can include receiving a 3D digital representation of an object. The method can include generating a plurality of grayscale slices corresponding to a plurality of 2D cross-sections of the 3D digital representation, where each grayscale slice comprises a plurality of grayscale units (e.g., 8-bit grayscale pixels or voxels). The method can also include generating a plurality of discretized slices based on the plurality of grayscale slices, where each discretized slice comprises a plurality of discretized units (e.g., 2-bit grayscale pixels or voxels). Each discretized unit can be generated by applying a discretizing function to a corresponding grayscale unit of a corresponding grayscale slice. For example, the discretizing function can be a probabilistic function (e.g., a stochastic function) based on the grayscale value of the grayscale unit. The method can further include outputting instructions for fabricating the object via an additive manufacturing process based on the plurality of discretized slices.

The present technology can provide numerous advantages compared to conventional techniques for generating object slices for additive manufacturing. Conventional techniques generally involve designing a 3D model of the object at a high resolution, then slicing the 3D model into a series of slices that are used by the additive manufacturing system to fabricate the object from a precursor material in a layer-by-layer manner. The slices are typically downsampled to the resolution of the additive manufacturing system, and discretized from a continuous volume/surface into individual binary voxels (e.g., black and white voxels) that correlate to the binary energy dosages (e.g., on and off) to be delivered to each voxel of material to form the object. However, details of the object geometry may be lost during the downsampling and discretization processes, such that the printed object does not accurately reproduce the intended shape of the object. This loss of fidelity may be problematic for medical devices such as dental appliances and/or other applications where high accuracy is important to ensure the printed object functions as intended.

Some of these issues may be mitigated through the use of grayscale voxels, which represent variable energy dosages to be delivered to the precursor material and therefore may improve object fidelity through spatial variations in the accumulated energy dosage and thus the degree of curing of the material. However, many additive manufacturing systems lack grayscale printing capabilities, or may only be capable of printing a limited range of grayscale values. For instance, fast laser scanning systems (e.g., used in stereolithography processes) may not be capable of modulating the power of the laser fast enough to obtain the desired spatial variation of power to achieve high resolution grayscaling, e.g., due to limits in analog power modulation frequency of lasers.

The present technology can address these and other challenges by generating object slices that produce improved object fidelity after printing, without requiring the use of grayscale-capable additive manufacturing systems. In some embodiments, the methods herein convert the initial 3D model into a discretized grayscale representation, which is then utilized to generate discretized (e.g., black and white, 2-bit grayscale) object slices in a probabilistic (e.g., stochastic) manner, using the grayscale values from the grayscale representation to determine the probability of voxel solidification. This technique, which may be referred to herein as “probabilistic discretization” or “stochastic discretization,” can capitalize on the inherent physical smoothing effects observed in certain additive manufacturing processes, such as light scattering, overcuring, surface tension, and frontal polymerization. By leveraging these phenomena, the resulting printed object can achieve a higher fidelity to the initial 3D model. In contrast to conventional binarization methods, which result in significant information loss, the approaches herein can preserve geometric details in a statistical manner, thus enhancing the resolution and fidelity of the printed object. Advantages of the approaches described herein may include, for example, improvements in geometric accuracy, improvements in surface smoothness and/or finish (e.g., layer lines may be less visible which may provide a better user experience), scalability in cases where accuracy requirements are not high, larger printing area with less resolution requirements, improved system and signal stability, and obviating the need for high resolution grayscale-capable systems and/or fast laser scanning systems. Moreover, the approaches herein are applicable to a diverse range of additive manufacturing technologies, including digital light processing, stereolithography, selective laser sintering, inkjet printing, binder jetting, continuous liquid interface production, two-photon induced photopolymerization, and volumetric additive manufacturing.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Generation of Object Slices via Probabilistic Discretization

The present technology relates to additive manufacturing (also referred to herein as “3D printing”), which includes a variety of technologies which fabricate 3D objects directly from digital models through an additive process. In some embodiments, for example, additive manufacturing includes depositing a precursor material (e.g., a polymerizable resin, a sinterable powder) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry. Additional details and examples of additive manufacturing techniques that are applicable to the present technology are described in Section II below.

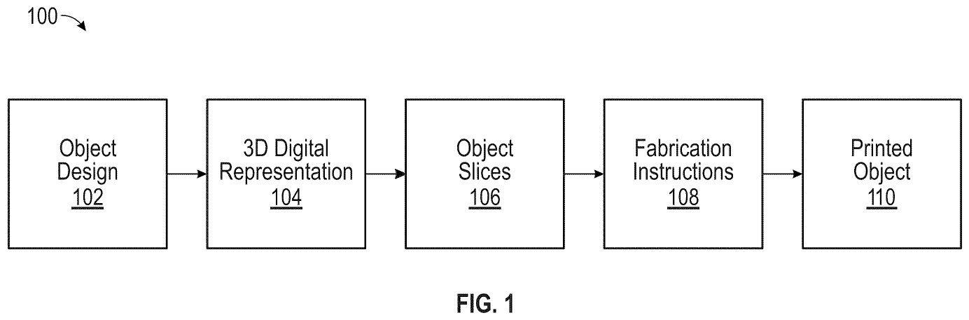

FIG. 1 is a flow diagram illustrating a workflow 100 for designing and fabricating an additively manufactured object, in accordance with embodiments of the present technology. The workflow 100 can begin with generating an object design 102 for the object. For example, the object can be a medical device, such as an orthodontic appliance (e.g., aligner, palatal expander, retainer, attachment placement device, attachment), restorative object (e.g., crown, veneer, implant), and/or other types of dental appliance (e.g., oral sleep apnea appliance, mouth guard). Additional examples of dental appliances and associated methods that are applicable to the present technology are described in Section III below.

In embodiments where the object is a dental appliance, the object design 102 can be based on a dental treatment plan for a patient's teeth. The treatment plan can include a target arrangement for the teeth and one or more treatment stages for achieving the target arrangement. For example, the treatment stages can be or include a series of intermediate tooth arrangements configured to incrementally reposition the teeth from an initial tooth arrangement toward the target tooth arrangement. In some embodiments, the dental appliance is an aligner or palatal expander that is worn the teeth to reposition one or more teeth according to a corresponding treatment stage of the treatment plan. Alternatively, the dental appliance can be a retainer that is worn on the teeth to maintain the teeth in a target arrangement according to a final or post-treatment stage of the treatment plan. The features of the dental appliance (e.g., shell, tooth-receiving cavities, attachment receptacles, tooth-contacting regions, non-tooth-contacting-regions, activations, bite ramps, mandibular advancement wings, cutlines) can be designed to produce the appropriate force systems and/or tooth movements for effectuating the corresponding treatment stage.

The workflow 100 can continue with generating a 3D digital representation 104 of the object design 102. The 3D digital representation 104 can be a 3D digital model depicting the 3D geometry of the object, such as a surface model, mesh model, non-parametric model, parametric model, etc. The 3D digital representation 104 can be provided in any suitable file format, such as a CAD file, STL file, OBJ file, AMF file, 3MF file, etc. In some embodiments, the 3D digital representation 104 is generated in a high resolution, which may correspond to the resolution of the software application used to produce the 3D digital representation 104 (e.g., CAD software).

The workflow 100 can also include generating a plurality of object slices 106 from the 3D digital representation 104. The object slices 106 can represent a plurality of layers for building up the object via a layer-by-layer additive manufacturing process (e.g., digital light processing (DLP), stereolithography (SLA), selective laser sintering (SLS), inkjet printing, binder jetting, continuous liquid interface production, two-photon induced photopolymerization, volumetric additive manufacturing). In some embodiments, the slicing process involves determining the locations of a plurality of slicing planes along the 3D digital representation 104. For instance, the slicing planes can be spaced apart from each other at a plurality of different vertical locations (e.g., z-positions) along the 3D digital model, with the spacing between the slicing planes corresponding to the height of an individual object layer. The object slices can then be generated by taking a plurality of 2D cross-sections of the 3D digital representation 104 at each slicing plane.

In some embodiments, the object slices 106 are 2D digital representations (e.g., images) that indicate how energy should be spatially applied to a precursor material (e.g., resin or powder) to fabricate the object, according to the layer-by-layer additive manufacturing process. For instance, each graphical unit (e.g., pixel) of the image can represent a corresponding volume unit (e.g., voxel) of a respective cross-section of the object, with the value of the graphical unit indicating whether the corresponding volume unit is part of the object and thus energy should be applied to the precursor material at that location, or whether the corresponding voxel is empty space and thus energy should not be applied to that location. The terms “pixel” or “voxel” are used interchangeably herein to refer to a unit of the object slice 106 that represents a 3D volume unit of an object cross-section. The object slices 106 can be provided in any suitable file format, such as VTK, VTI, PNG, BMP, DICOM, etc.

In some embodiments, the object slices 106 are binary slices including a plurality of binary voxels (e.g., black and white voxels). The binary voxels can represent binary energy dosages to be applied to the precursor material to form the object cross-section, e.g., black voxels indicate that no energy is applied to a particular spatial location in the material, while white voxels indicate that energy at a fixed dosage is applied to a particular spatial location in the material. Alternatively or in combination, the binary voxels can represent binary degrees of curing of the material, e.g., black voxels indicate that no curing should occur at that particular spatial location, while white voxels indicate that curing should occur at that particular spatial location.

Alternatively, the object slices 106 can be grayscale slices including a plurality of grayscale voxels (e.g., voxels having a plurality of different possible grayscale values between black and white). The grayscale voxels can represent variable energy dosages to be applied to the precursor material to form the object cross-section, with the variable energy dosages being selected from a range of energy dosages (e.g., black is 0% of the maximum energy dosage, white is 100% of the maximum energy dosage, 50% gray is 50% of the maximum energy dosage, etc.). Alternatively or in combination, the grayscale voxels can represent variable degrees of curing of the material (e.g., black is no curing, white is the maximum degree of curing, 50% gray is 50% of the maximum degree of curing, etc.). The range of energy dosages/degree of curing can be a continuous range (e.g., from 0% to 100% of the maximum energy dosage/degree of curing) or can be a range composed of more than two discrete values (e.g., 0%, 10%, 20%, 30%, 40%, 50%, 60%, 70%, 80%, 90%, and 100% of the maximum energy dosage/degree of curing). The grayscale slices can have any suitable resolution, such as 2-bit grayscale, 4-bit grayscale, or 8-bit grayscale.

In some embodiments, the slicing process involves converting the object geometry from the resolution of the 3D digital representation 104 into the print resolution of the additive manufacturing system. For example, in embodiments where the 3D digital representation 104 is a mesh or surface model, the slicing process can involve converting (e.g., downsampling and/or discretizing) the model into a plurality of discrete geometric units (e.g., voxels or pixels) to match the print unit shape and resolution used by the additive manufacturing system (e.g., DLP systems can use a plurality of square pixels, SLA systems may use a circular spot that follows contours). In some embodiments, the print resolution of the additive manufacturing system can be approximately 50 μm in the x- and y-directions, and approximately 100 μm in the z-direction. The resolution of the 3D digital representation 104 may be at least 10×, 100×, or 1000× higher than the print resolution of the additive manufacturing system.

Subsequently, the workflow can produce a set of fabrication instructions 108 from the object slices 106. As described herein, the additive manufacturing system can be configured to apply energy to a precursor material (e.g., a resin or powder) to cure, polymerize, melt, sinter, fuse, or otherwise solidify the precursor material into an individual cross-section (e.g., layer) of the object. The energy can be applied according to the data in the corresponding object slice 106 for that cross-section. For instance, the voxel value at a particular location in an image can indicate whether energy should be applied to a corresponding voxel in the precursor material to form a portion of the object, and, optionally, the parameters of the energy to be applied to that location (e.g., intensity, exposure time, dosage, wavelength). In some embodiments, the object slices 106 are black and white images (and/or tensors generated from the images), with white voxels indicating that energy should be applied and black voxels indicating that energy should not be applied, or vice-versa. In other embodiments, the object slices 106 can be grayscale images, with the grayscale values of the voxels corresponding to the desired energy dosage (e.g., intensity and/or exposure time) to be applied. Grayscale images can be used, for example, if the object is intended to have heterogenous properties (e.g., varying degrees of curing may produce variations in properties such as modulus, glass transition temperature, etc.). The fabrication instructions can be any data type that can be used by the additive manufacturing system for fabricating the object. For example, the fabrication instructions can include the images, and/or can include other data generated based on the images, such as a toolpath file (e.g., G-code file).

Based on the fabrication instructions 108, a printed object 110 can be fabricated by an additive manufacturing system. The additive manufacturing system can include an energy source (e.g., a laser, projector, light engine), a source of a precursor material (e.g., a vat, carrier film, powder bed), and/or other devices configured to perform the various additive manufacturing processes described herein. Optionally, after fabrication, the printed object 110 can undergo post-processing, such as removing excess material, post-curing, annealing, cleaning, trimming of support structures, surface modifications, etc. Post-processing may be performed by various devices, such as one or more centrifuges, solvent baths, post-curing and/or annealing ovens, trimming systems, etc.

In some instances, the actual geometry of the additively manufactured object may deviate from the intended geometry specified by the object design, which may compromise the function of the object. For instance, certain types of dental appliances can have small and/or detailed features with strict manufacturing tolerances. Regions of the dental appliance that are important or necessary for certain functions (e.g., clinical efficacy, proper positioning, ergonomics, mechanical properties, aesthetics) may also be subject to strict tolerances. For example, the tolerance for certain features and/or regions of a dental appliance can be less than or equal to 500 μm, 200 μm, 100 μm, 50 μm, 20 μm, or 10 m. If there is significant loss of fidelity in such features and/or regions during the manufacturing process—for instance, if the actual size, shape, and/or location of the features and/or regions deviates from the intended size, shape, and/or location by more than the tolerance—the appliance may fail to print properly and/or may be unsuitable for its intended function.

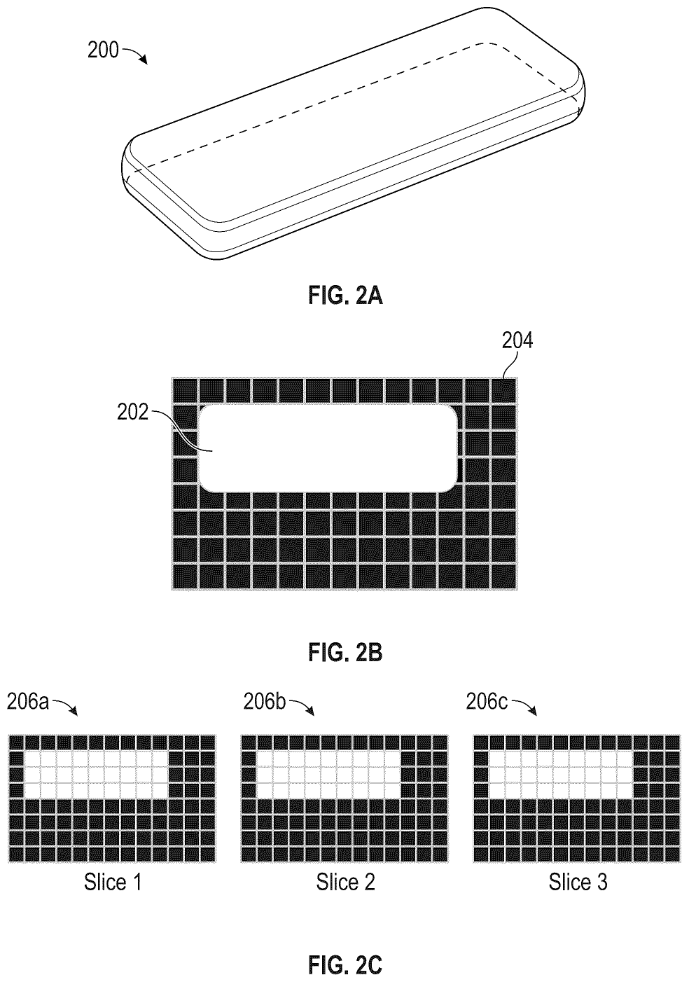

FIGS. 2A-2C illustrate an example of loss of fidelity that may occur when generating object slices for additive manufacturing. Specifically, FIG. 2A illustrates a 3D digital representation 200 of an object, FIG. 2B illustrates a cross-section 202 of the 3D digital representation 200 overlaid onto a grid 204 representing the resolution of the additive manufacturing system, and FIG. 2C illustrates a plurality of object slices 206 generated from the 3D digital representation 104.

Referring first to FIG. 2A, the 3D digital representation 200 can be a digital model (e.g., a surface model, a mesh model) depicting the 3D geometry of the object at a high resolution. In the illustrated example, the object is a rectangular prism with rounded corners.

Referring next to FIGS. 2B and 2C together, the object geometry may be converted into a plurality of binary object slices 206a-206c (collectively, “object slices 206”) for layer-by-layer additive manufacturing. The object slices 206 can represent cross-sections of the object taken at different spatial locations along the object, e.g., slice 206a corresponds to a first vertical location, slice 206b corresponds to a second vertical location, slice 206c corresponds to a third vertical location, etc. Each object slice 206 can include a plurality of black and white voxels representing binary energy dosages to be applied to a precursor material to fabricate a corresponding cross-section 202 of the object. Specifically, white units in the object slices 206 represent locations where energy should be applied to form a portion of the object, and black units represent locations where energy should not be applied thereby leaving an empty space.

As best seen in FIG. 2B, the resolution of the additive manufacturing system (represented by grid 204, in which the size of the squares corresponds to the unit size of the system) is lower than the resolution of the 3D digital representation 200, such that the object geometry needs to be downsampled to produce the binary object slices 206. In the illustrated example, the downsampling process involves setting each unit in the object slice 206 to be black or white using a predetermined binarization threshold, e.g., the unit is black if less than 50% of the area of the unit is occupied by the object, and the unit is white if at least 50% of the area of the unit is occupied by the object. This binary “hard-threshold” approach can result in loss of geometric information. For instance, the original object cross-section 202 has a dimension of 9.5 units by 3.4 units, but the resulting object slices 206 only have dimensions of 9 units by 3 units because the edges of the object did not meet the binarization threshold and thus were set to black. Similarly, the rounded corners of the object have been lost in the object slices 206 because the feature size of the rounded corners is smaller than the unit size of the additive manufacturing system. Thus, the actual geometry of the object fabricated according to the object slices 206 will deviate from the intended geometry specified by the 3D digital representation 200.

The present technology provides techniques for generating binary object slices that improve the fidelity of the additively manufactured object to the intended object geometry. In some embodiments, the techniques described herein utilize probabilistic (e.g., stochastic) approaches to set the binary value of each unit in the object slice, such that the cumulative effect of the applied binary energy dosages produces a printed object geometry that more closely resembles the intended geometry. This approach allows for the statistical preservation of geometric information, thus allowing a substantial increase in the resolution and fidelity of printed objects and/or achieving sub-pixel level accuracy that surpasses conventional binarization approaches.

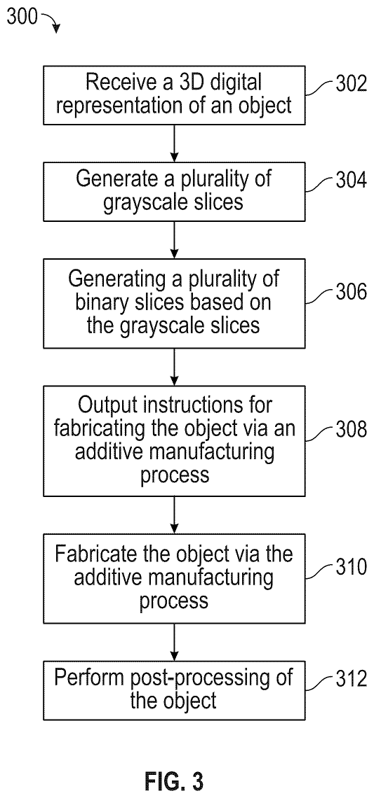

FIG. 3 is a flow diagram illustrating a method 300 for generating object slices for additive manufacturing, in accordance with embodiments of the present technology. The method 300 can be used to produce many different types of additively manufactured objects, such as any of the dental appliances described herein. In some embodiments, some or all of the processes of the method 300 are implemented as computer-readable instructions (e.g., program code) that are configured to be executed by one or more processors of a computing device (e.g., an appliance design system and/or a controller of an additive manufacturing system).

The method 300 can begin at block 302 with receiving a 3D digital representation of an object to be fabricated via an additive manufacturing process. The 3D digital representation can be a 3D digital model depicting the 3D geometry of the object, such as a surface model, mesh model, non-parametric model, parametric model, etc. The 3D digital representation can be provided in any suitable file format, such as a CAD file, STL file, OBJ file, AMF file, 3MF file, etc. In some embodiments, the 3D digital representation is generated in a high resolution, which may correspond to the resolution of the software application used to produce the 3D digital representation (e.g., CAD software).

At block 304, the method 300 can include generating a plurality of grayscale slices, based on the 3D digital representation. The grayscale slices can correspond to a plurality of 2D cross-sections (e.g., layers) of the 3D digital representation that are taken at different vertical locations along the 3D digital representation, with the spacing between the vertical locations corresponding to the height of the object cross-sections. Each grayscale slice can include a plurality of grayscale units, such as grayscale voxels (e.g., voxels having a plurality of different possible grayscale values between black and white). The size of the grayscale voxels can correlate to the resolution of the additive manufacturing system, which may be lower than the resolution of the 3D digital representation as discussed elsewhere herein.

The range of grayscale values for the grayscale voxels can be a continuous range of grayscale values or can be a range composed of three or more discrete grayscale values. In some embodiments, the grayscale voxels correlate to variable energy dosages and/or degrees of curing that would be used to form the object cross-section, if an additive manufacturing system with grayscaling capabilities were used. Alternatively or in combination, the grayscale voxels can correlate to a “density” of the object at each voxel of the object cross-section, e.g., the grayscale value is black if the voxel is empty space, the grayscale value is white if the voxel is completely occupied by the object, the grayscale value is 50% gray if 50% of the volume of the voxel is occupied by the object and the remaining 50% of the volume is occupied by empty space, the grayscale value is 25% gray if 25% of the volume of the voxel is occupied by the object and the remaining 75% of the volume is occupied by empty space, etc. Thus, the grayscale voxels can preserve finer details of the object geometry than would be possible if the 3D digital representation were converted directly to binary voxels.

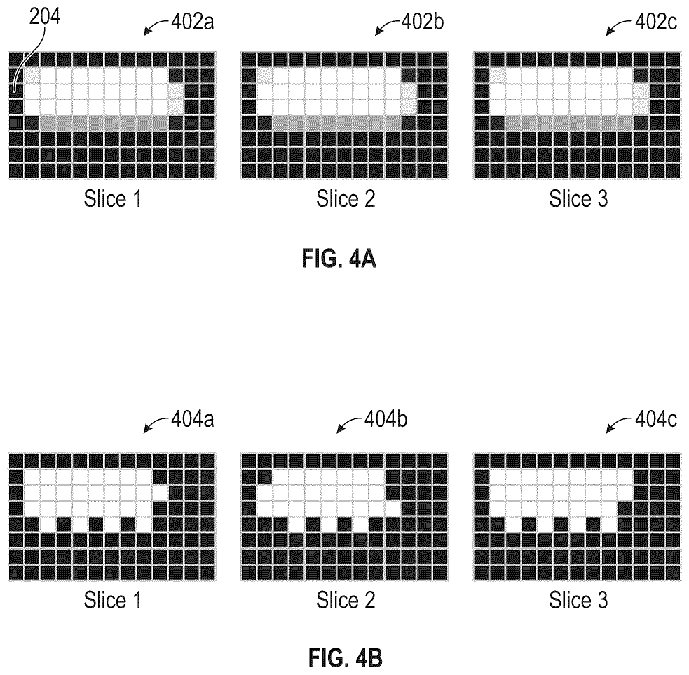

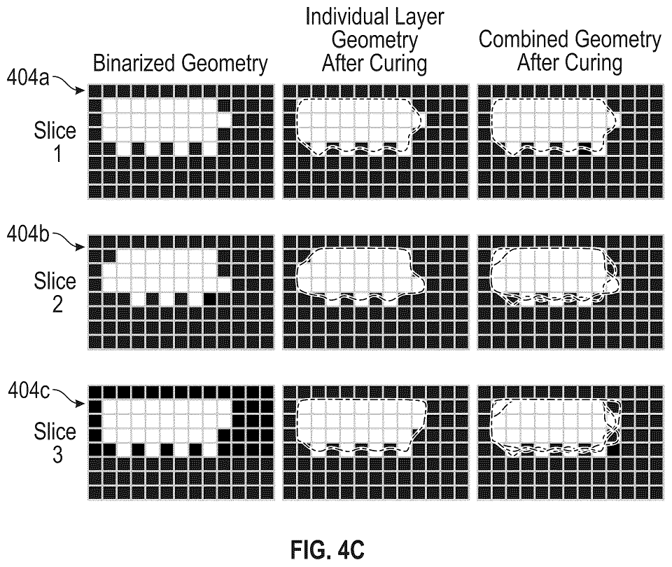

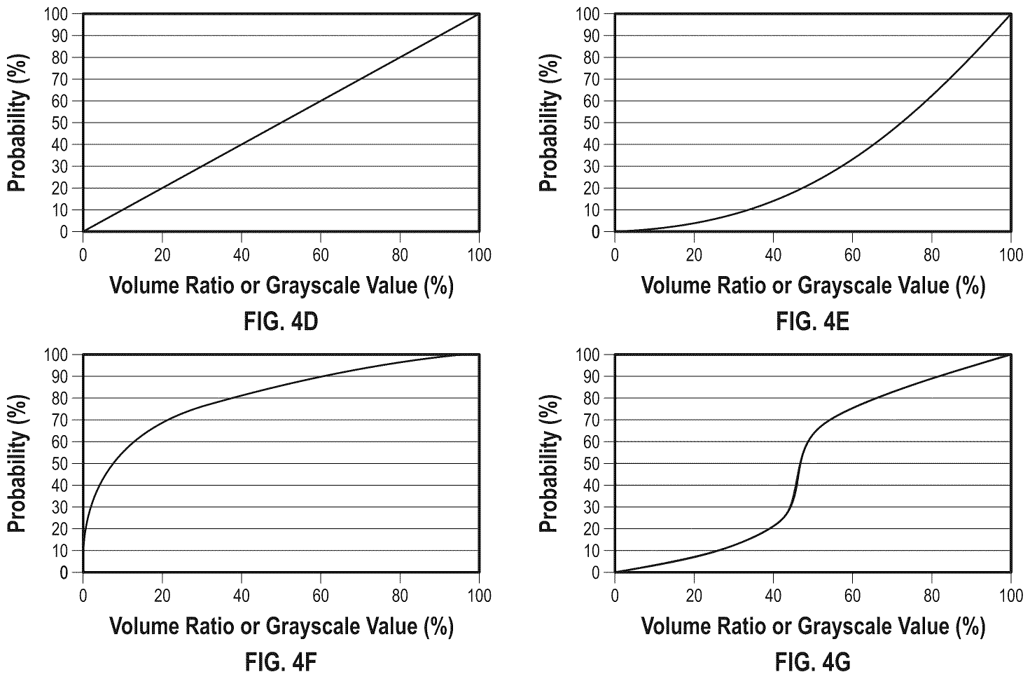

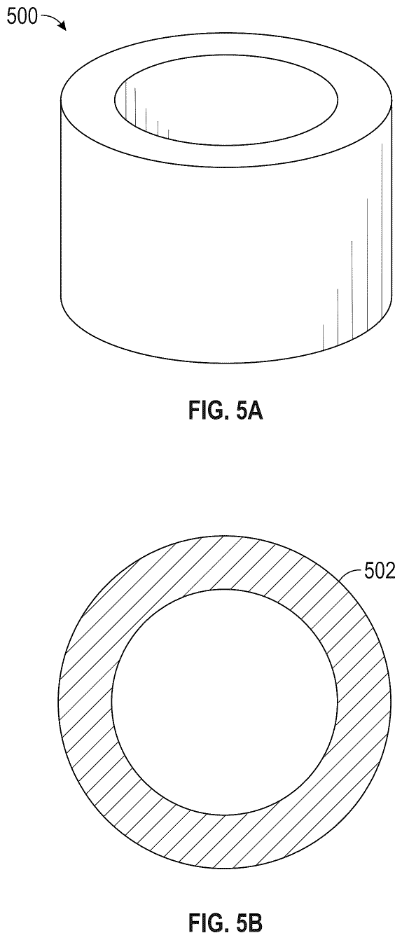

For example, FIG. 4A illustrates a plurality of grayscale slices 402a-402c (collectively, “grayscale slices 402”) generated from the 3D digital representation 200 of the object of FIG. 2A, in accordance with embodiments of the present technology. The grayscale slices 402 can represent cross-sections of the object taken at different spatial locations along the object, e.g., grayscale slice 402a corresponds to a first vertical location, grayscale slice 402b corresponds to a second vertical location, grayscale slice 402c corresponds to a third vertical location, etc. Each grayscale slice 402 can include a plurality of grayscale voxels generated by downsampling and discretizing the 3D digital representation 200 into the resolution of the additive manufacturing system (represented by grid 204). Comparing the grayscale slices 402 in FIG. 4A to the binary object slices 206 in FIG. 2C, it can be seen that the grayscale slices 402 more accurately reflect the original object geometry, e.g., the intermediate grayscale values at the corners and edges of the grayscale slices 402 preserve some of the geometric information for the original rounded corners and dimensions of the object, whereas such geometric information was entirely lost in the binary object slices 206.

Referring again to block 304 of FIG. 3, in some embodiments, the grayscale slices are generated using a grayscaling function. The grayscaling function can be a rule-based algorithm, a machine learning algorithm (e.g., a convolutional neural network), or suitable combinations thereof. The input to the grayscaling function can be the 3D digital representation, and the output of the grayscaling function can be the plurality of grayscale slices. The grayscaling function can downsample and discretize the geometry of the 3D digital representation from a continuous volume/surface into a plurality of discrete grayscale voxels, with the size of the voxels correlating to the resolution of the additive manufacturing system. The grayscaling function can output the grayscale slices in any suitable file format, such as VTK, VTI, PNG, BMP, DICOM, etc. Optionally, the grayscale slices may be output as images that are subsequently converted to tensors.

Many different types of grayscaling functions can be used to generate the grayscale slices. In some embodiments, the grayscaling function uses a volume ratio approximation method to generate grayscale slices (as used herein, “volume ratio” or “volumetric ratio” refers to the proportion of the voxel that is filled with the object rather than with empty space). For example, the grayscaling function can use higher resolution slicing with averaging and downsampling, where the 3D digital representation is sliced at a higher resolution than the printing resolution, then the voxel intensities within each region are averaged to produce grayscale values and downsampled to the final resolution, thereby preserving the volume ratio in the voxel grid. This approach can be applied in the x-y plane only, in the z-direction only, or in both the x-y plane and the z-direction. A stochastic in-layer offset may be applied in the z-direction (e.g., within a range from 0 μm to 100 μm) to change the slicing location. This approach can allow detailed internal structure representation and smooth transitions between layers.

As another example, the grayscaling function can use higher resolution sampling near the surface of the object, converting regions close to the surface into grayscale slices where the intensity values represent the fraction of each voxel occupied by the object. This approach can provide precise surface detail representation while optimizing computational resources in the interior of the object.

In a further example, the grayscaling function can be a voxel-based grayscale interpolation function that converts the 3D digital representation into a voxel-based representation and uses interpolation techniques (e.g., trilinear interpolation) to assign grayscale values based on the fraction of volume each voxel occupies. This approach can allow for smoother transitions between occupied and unoccupied regions by assigning partial voxel values.

As another example, the grayscaling function can apply anti-aliasing to binary slices generated from the 3D digital representation through hard threshold binarization, where the anti-aliasing softens hard edges and produces grayscale values that that represent partial voxel occupancy. This approach can leverage binary slicing algorithms while adding a smoothing step for easier implementation.

In a further example, the grayscaling function can utilize adaptive slicing with varying slice thickness and voxel resolution according to the local geometry of the 3D digital representation, where the grayscale values are calculated based on the volume ratio within each voxel, thereby reducing computational load while maintaining accuracy in complex regions.

In yet another example, a marching cubes algorithm can be used to extract a surface mesh from the 3D digital representation, then grayscale slices can be generated based on the distance of each voxel to the surface. This approach can provide a smooth surface approximation and accurate partial volume occupancy representation.

As a further example, a density-based slicing algorithm can be used, where grayscale slices are generated with the grayscale intensity of each voxel corresponding to the local material density, thus allowing for a more accurate physical representation of the geometry (e.g., in multi-material or gradient-based printing).

In another example, a distance field slicing algorithm can be used, where a signed distance field (SDF) that assigns grayscale values based on proximity to the surface is generated for the 3D digital representation. This approach can ensure smooth transitions between empty and fully occupied regions, thereby preserving surface details.

In a further example, an implicit surface function for grayscale calculations can be used, in which the object is represented as an implicit surface and sampled at different grid points, and grayscale values are computed by evaluating the fraction of the voxel inside the surface. This approach can be suitable for complex geometries and smooth surfaces.

As another example, a supervoxel-based volume representation can be used, in which small voxels are grouped into larger supervoxels and grayscale values are assigned based on the percentage of smaller voxels occupied by the object. This approach may optimize resolution and computational cost by averaging smaller units into larger grayscale representations.

In yet another example, a ray-casting algorithm can be used to cast rays through the object along the slicing plane, with grayscale values computed based on the fraction of the object intersected by each ray in a voxel. This approach can produce smooth transitions and can provide good results for complex geometries with thin structures.

In a further example, a multiscale grid can be used, with higher-resolution slices in regions of higher detail and lower-resolution slices elsewhere, and grayscale values can be generated by averaging occupancy at different scales. This approach can balance computational efficiency with high fidelity in critical regions.

As another example, grayscale slices can be created using a smooth transition function (e.g., sigmoid function) to blend occupied and unoccupied regions, thereby producing gradual transitions between voxels. This method can provide a smooth and continuous representation of object boundaries.

As a further example, a gradient-based slicing algorithm can be used, where the gradient of the object's surface is computed and used to generate grayscale slices where intensity reflects the occupancy of each voxel based on its proximity to the surface. This approach can ensure smooth transitions and can be particularly useful for soft or curved boundaries.

In another example, a voxel morphing and grayscale mapping algorithm can be used, where the designed object's surface is morphed into a voxel grid, then grayscale values are mapped according to the amount of overlap between the designed object and the grid, thus offering flexibility in representing complex shapes smoothly.

In some embodiments, the grayscaling function uses a slice image smoothing method to produce grayscale slices. For example, a Gaussian filtering algorithm can be used, where a Gaussian kernel is used to smooth the image, reducing noise and preserving the overall structure by convolving the image with a Gaussian distribution.

As another example, various filters such as averaging, median, Gaussian kernels, etc., can be applied to the grayscale image to achieve smoothing by reducing noise and blending pixel values.

In another example, a trained convolutional neural network (or other deep learning algorithm) can be used to apply learned filters that convert binary images to grayscale images that are then smoothed through convolution layers optimized for the task.

In a further example, a bilateral filtering algorithm can be used, where Gaussian smoothing in both the spatial and intensity domains is combined to reduce noise while preserving edges by considering pixel proximity and intensity similarity.

As yet another example, a median filtering algorithm can be used to replace the value of each pixel with the median of the neighboring pixels, which can effectively reduce “salt-and-pepper” noise while maintaining edge details.

In another example, an anisotropic diffusion process can be used to smooth homogeneous regions of the image while limiting diffusion near the edges, thereby preserving important features.

As a further example, a Laplacian of Gaussian (LoG) algorithm can be used, where Gaussian smoothing is first applied and a Laplacian filter is then used to highlight regions of rapid intensity change, thus producing smoothing while enhancing edges.

As another example, a non-local means (NLM) algorithm can be used to average similar patches of the image, thereby preserving important details and textures while removing noise.

In a further example, a wavelet-based denoising algorithm can be used, where the image is decomposed into multiple frequency components using wavelet transforms, then noise is removed from higher-frequency components before reconstructing the smoothed image.

In yet another example, a Fourier transform-based filtering algorithm can be used, where the image is converted into the frequency domain and a low-pass filter is applied to remove high-frequency noise, followed by reconstruction in the spatial domain.

As another example, a morphological operations (dilation and erosion) algorithm is used, where dilation and erosion are applied to modify the structure of objects in the image, thereby smoothing shapes and edges while maintaining larger structures.

In another example, a guided filtering algorithm can be used, where a guidance image (e.g., the original image) is used to smooth the image while preserving edges and larger structures by considering both spatial and intensity relationships.

In a further example, a total variation (TV) denoising algorithm can be used to minimize the total variation of the image, resulting in smooth regions while preserving edges through an optimization approach.

As yet another example, a Sobel/Prewitt filtering algorithm can be used to smooth image transitions by highlighting areas of intensity change.

In some embodiments, the grayscaling function uses a predetermined pattern to produce the grayscale slices. For example, a surface-based grayscale patterning algorithm can be used, where grayscale patterns are predesigned along the surface of the subject to control exposure and/or curing at specific points, thus allowing fine-tuning of surface textures and finishes. This approach may be useful for controlling roughness, smoothness, and/or surface characteristics where precision is critical.

As another example, predesigned gradient grayscale patterns can be used to create gradual transitions in material properties, such as stiffness, flexibility, etc. This approach allows for functional grading in applications such as medical devices, prosthetics, etc., that involve soft-to-hard transitions.

In another example, repeating or tessellated grayscale patterns can be applied to guide the curing process for specific effects, such as controlling mechanical stress, heat distribution, and/or optical properties. This approach can be useful for printing lattice structures or metamaterials with tailored internal patterns, for example.

In a further example, geometric features such as curvature and/or surface normal can be used to assign grayscale values, thereby tailoring the mechanical behavior of parts. For example, reducing exposure in areas of high curvature may optimize material density and/or strength in specific regions.

As yet another example, voxel-level predetermined grayscale maps can be used to define grayscale patterns at the voxel level for finer control of individual voxel exposure. This approach can provide high-precision control over detailed features, making it suitable for applications such as microfabrication, optical component manufacturing, etc.

As a further example, grayscale maps can be created to manage heat distribution during curing, e.g., by adjusting exposure to prevent overheating or under-curing. This approach may be beneficial for parts where thermal stresses should be controlled to prevent warping or shrinkage.

In another example, directional grayscale patterns can be used to vary exposure based on direction relative to the surface normal and/or build orientation. This approach allows for the creation of parts with anisotropic material properties, which may be useful for aerospace or automotive components requiring different strength or flexibility along different axes, for example.

As yet another example, localized grayscale variations can be applied to create multifunctional components, with different regions of the object offering varied optical, mechanical, and/or conductive properties. This may be useful for complex parts in electronics, optics, medical devices, and/or other applications where different regions serve different functions.

In some embodiments, the grayscaling function predicts the energy distribution and/or curing pattern that will result from an initial set of grayscale slices, and adjusts (e.g., optimize) some or all of the grayscale slices to compensate for deviations (e.g., due to light scattering, overcuring, etc.) so that the predicted energy distribution and/or curing pattern correspond more closely to the desired object geometry (also referred to herein as “deviation prediction and compensation”). This approach can be used, for example, to identify and remove islands and/or other undesirable artifacts in the object geometry.

In some embodiments, divide and conquer algorithms can be used to convert subregions of the object into grayscale, and the subregions can subsequently be combined into a single grayscale slice. Sampling on surface adjacent areas can also be performed and combined with subsequently generated binary slices.

At block 306, the method 300 can continue with generating a plurality of binary slices based on the grayscale slices. Each binary slice can include a plurality of binary units, such as binary (e.g., black and white) voxels. The binary voxels can represent binary energy dosages to be applied to the precursor material to form the object cross-section, e.g., black voxels can represent locations where no energy is applied, and white voxels can represent locations where a fixed energy dosage is applied. Alternatively or in combination, the binary voxels can represent binary degrees of curing of the material, e.g., black voxels indicate that no curing should occur at that particular location, while white voxels indicate that curing should occur at that particular location. The size of the binary voxels can correlate to the resolution of the additive manufacturing system, and may be the same as the size of the grayscale voxels of the grayscale slices.

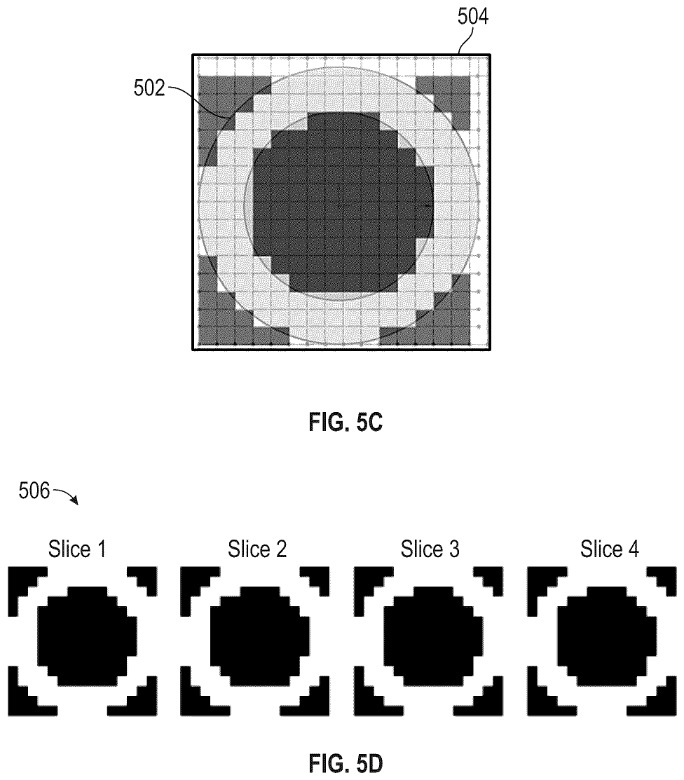

In some embodiments, each binary slice is generated from a corresponding grayscale slice. The binary slices can collectively represent a plurality of object cross-sections at different vertical locations along the object. Optionally, at least some of the binary slices can represent different energy patterns to be applied at the same vertical location of the object (e.g., as discussed further below in connection with FIGS. 5A-5H). Each binary voxel for a binary slice can be generated based on a corresponding grayscale voxel of the corresponding grayscale slice. The corresponding grayscale voxel can be the voxel at the same location in the grayscale slice as the location of the binary voxel in the binary slice, e., the grayscale voxel at position (0, 0) in the grayscale slice is used to generate the binary voxel at position (0, 0) in the binary slice, the grayscale voxel at position (1, 0) in the grayscale slice is used to generate the binary voxel at position (1, 0) in the binary slice, etc.

In some embodiments, the binary voxel is generated by applying a binarizing function to the grayscale voxel to convert the grayscale value of the grayscale voxel to a binary value for the binary voxel. The binarizing function can use a probability distribution to determine the binary value, where the probability distribution that is sampled to select the binary value is based on the grayscale value. For instance, grayscale values closer to black may have a higher probability of producing a black binary value, while grayscale values closer to white may have a higher probability of producing a white binary value. As an example, if the grayscale value is 50% gray, the binary voxel can have a 50% probability of being set to white and 50% probability of being set to black; if the grayscale value is 25% gray, the binary voxel can have a 25% probability of being set to white and a 75% probability of being set to black; if the grayscale value is black, the binary voxel can have a 100% probability of being set to white; if the grayscale value is white, the binary voxel can have a 100% probability of being set to white etc. The binarizing function can be a fully stochastic function, in that the binary value is produced by purely random sampling of the probability distribution. Alternatively, the binarizing function can be a partially stochastic or non-stochastic function, in that there may be weighting, periodic patterning, or other non-randomized approaches used to determine the binary value.

In some embodiments, the probability distribution represents a relationship between the grayscale value or volume ratio of a particular grayscale voxel, and the probability that the corresponding binary voxel in the binary slice will be “on” (e.g., set to white). The probability distribution can be represented by a linear function or a nonlinear function (e.g., a polynomial function, logarithmic function, sigmoid function, etc.). For example, a linear binarizing function (e.g., as shown in FIG. 4D) can be used in situations where the probability of the binary voxel being “on” is directly proportional to the grayscale value (e.g., a grayscale value of 50% correlates to a 50% chance of being “on,” a grayscale value of 100% correlates to a 100% chance of being on, etc.). This approach can produce a smooth linear relationship between the grayscale value and the probability of printing, which can provide a more accurate representation of intermediate volume ratios compared to conventional hard threshold binarization.

Nonlinear binarizing functions can be used to introduce nonlinearity in the probability distribution, e.g., to accentuate or diminish certain grayscale ranges. For example, a quadratic-like function (e.g., as shown in FIG. 4E) can be used, where lower grayscale values are assigned lower probabilities, but the probability increases rapidly as the grayscale value approaches 100%. As another example, a logarithmic-like function (e.g., as shown in FIG. 4F) can be used, where the probability increases more quickly for lower grayscale values but plateaus as the grayscale value approaches 100%. This relationship may reflect a nonlinear behavior resembling the gel-point threshold in photopolymerization, e.g., voxels receiving a light dose above a certain threshold can begin curing, and beyond that threshold, the process stabilizes. In a further example, a sigmoid-like function (e.g., as shown in FIG. 4G) can be used, where the middle range of grayscale values has the most variability in probability, but near the extremes (e.g., 0% and 100%), the probability stabilizes quickly to either 0% or 100%. In general, nonlinearity may provide greater control over how intermediate grayscale values are translated to binary states, thereby allowing for custom tailoring of the binarization process. These approaches may be particularly useful when finer control is needed over the distribution of printed voxels, e.g., based on specific design requirements.

In some embodiments, the probability distribution is based on a distribution for the degree of curing of the precursor material, rather than based on the applied energy dosage (e.g., energy intensity) or input control signal for the energy source. This approach may be appropriate, for example, if the response of the material to the energy dosage is highly non-linear, e.g., as discussed above with respect to the gel-point threshold for photopolymerization. In such embodiments, techniques such as inverse transform sampling can be used to select the appropriate binary value from the probability distribution.

For example, FIG. 4B illustrates a plurality of binary slices 404a-404c (collectively, “binary slices 404”) generated from the grayscale slices 402 of FIG. 4A, in accordance with embodiments of the present technology. Each binary slice 404 can be generated from a corresponding grayscale slice 402, e.g., binary slice 404a is generated from grayscale slice 402a, binary slice 404b is generated from grayscale slice 402b, and binary slice 404c is generated from grayscale slice 402c. The grayscale values of the grayscale voxels in the grayscale slices 402 can be used to determine the binary values of the binary voxels in the binary slices 404 in a partially or fully stochastic manner. Stated differently, the grayscale slices 402 can represent a probability distribution for the binary values of each voxel, and the binary slices 404 can be the set of binary values selected by sampling the probability distribution in a partially or fully random manner. In the illustrated example, although the grayscale slices 402 have the same geometry, the binary slices 404 produced from the grayscale slices 402 each have different geometries due to the probabilistic nature of the binarizing function.

Referring again to block 306 of FIG. 3, the binarizing function can output the binary slices in any suitable file format, such as VTK, VTI, PNG, BMP, DICOM, etc. Optionally, the binary slices may be output as images that are subsequently converted to tensors. In some embodiments, a first tensor is used to represent a 3D array containing grayscale values corresponding to the volume ratio of the designed object in voxel space, and a second tensor is used to represent a 3D array containing binary values after the binarizing function has been applied to the grayscale values. The use of tensors or 3D arrays for processing may be significantly more efficient than processing of images, e.g., due to more streamlined operations, better memory management, and faster computations. Accordingly, any reference herein to processes performed on images and/or slices can also be applied to processes performed on tensors or 3D arrays generated from such images and/or slices.

At block 308, the method 300 can include outputting instructions for fabricating the object via an additive manufacturing process, based on the binary slices. As described herein, the binary voxels of the binary slices can correspond to the binary energy dosages to be applied to various spatial locations of the precursor material and/or can indicate whether the material at various locations should or should not be cured. Accordingly, the binary slices can be used to generate instructions for controlling the additive manufacturing system (e.g., energy intensity, locations where energy is applied) to fabricate the object, with each binary slice being used to produce instructions for an individual layer of the object.

At block 310, the method 300 can include fabricating the object via the additive manufacturing process. Examples of additive manufacturing processes that may be used include DLP, SLA, SLS inkjet printing, binder jetting, continuous liquid interface production, two-photon induced photopolymerization, and volumetric additive manufacturing. The additive manufacturing process can include controlling an energy source to apply energy (e.g., light) to selected locations of a precursor material (e.g., a polymerizable resin) to cause the material to become cured, polymerized, melted, sintered, fused, and/or otherwise solidified to form the object in a layer-by-layer manner. For example, the energy source can be a light engine, a projector, or a scanning laser system.

In some embodiments, certain chemical and/or physical phenomena that may occur during the additive manufacturing process can cause the actual object geometry to become smoothed compared to the geometry of the binary slices, such as light scattering, overcuring, surface tension of the precursor material (e.g., resin), tracking of the precursor material, and/or frontal polymerization. Moreover, the vertical stacking of multiple object layers can result in smoothing in the vertical direction and/or in the cumulative object geometry becoming closer to the designed geometry due to statistical regression effects. Thus, higher object fidelity can be achieved even though binary slices are used.

For example, FIG. 4C illustrates an object geometry produced by an additive manufacturing process based on the binary slices 404 of FIG. 4B, in accordance with embodiments of the present technology. As shown in the leftmost images of FIG. 4C, the object geometries depicted by the binary slices 404 are represented as a plurality of discrete black and white voxels, with each voxel having a square shape. The binary slices 404 can be used to control an additive manufacturing system (e.g., a DLP system) to apply energy to cure a precursor material (e.g., a resin) to sequentially form individual layers of an object. As shown by the broken lines in the middle images of FIG. 4C, the actual contours of the individual object layers may be smoothed compared to the contours of the binary slices due to the chemical and/or physical phenomena described herein. Moreover, as shown in the rightmost images of FIG. 4C, due to the statistical approach used to design the binary slices 404, when combined the geometry of the individual object layers regresses toward the initial object design (the rounded rectangle shown in FIG. 2A), thereby providing improved fidelity.

At block 312, the method 300 can optionally include performing post-processing of the object. Post-processing may include, for example, removing excess material, post-curing, annealing, cleaning, trimming of support structures, and/or surface modifications to the object. In some embodiments, post-processing may produce further smoothing of the object geometry. For instance, residual material remaining on the object surface after centrifugation may become incorporated into the object during post-curing, thus providing an additional smoothing effect that can further enhance the fidelity of the object geometry to the initial design.

The method 300 illustrated in FIG. 3 can be modified in many different ways. For example, although the above processes of the method 300 are described with respect to a single object, the method 300 can be used to sequentially or concurrently design and fabricate any suitable number of objects, such as tens, hundreds, or thousands of additively manufactured objects. As another example, the ordering of the processes shown in FIG. 3 can be varied. Some of the processes of the method 300 can be omitted (e.g., the process of blocks 310 and/or block 312), and/or the method 300 can include additional processes not shown in FIG. 3.

Moreover, in some embodiments, the processes of the method 300 may not be applied to the entire object geometry concurrently. Instead, a divide-and-conquer approach may be used, e.g., subregions of the object geometry can be grayscaled and binarized individually and subsequently recombined. This approach can be advantageous for improving computational speed via parallel processing.

FIGS. 5A-16C illustrate additional techniques that may be used in combination with the methods for generating object slices described herein, such as the method 300 of FIG. 3. Moreover, any of the embodiments described in connection with FIGS. 5A-16C may be combined with each other.

FIGS. 5A-5H illustrate processes for producing object slices to improve the fidelity of an additively manufactured object, in accordance with embodiments of the present technology. FIG. 5A illustrates a 3D digital representation 500 of an object and FIG. 5B illustrates a cross-section 502 of the 3D digital representation 500. The rounded shape of the object may be challenging to fabricate accurately with additive manufacturing systems that utilize square pixels or other non-rounded unit shapes. For example, FIG. 5C illustrates the cross-section 502 overlaid onto a grid 504 representing the resolution of a DLP additive manufacturing system, and FIG. 5D illustrates a plurality of binary slices 506 generated by directly converting the 3D digital representation 500 into the resolution of the DLP system using a hard binarization threshold. As shown in FIG. 5D, the rounded shape of the object geometry is lost in the binary slices 506.

FIGS. 5E-5G illustrate a process for producing object slices in the spatial domain with improved fidelity. FIG. 5E illustrates the cross-section 502 overlaid onto the grid 504 representing the resolution of the DLP additive manufacturing system, and FIG. 5F illustrates a plurality of grayscale slices 508 generated by converting the 3D digital representation 500 into the resolution of the DLP system using a grayscaling function in accordance with the techniques described herein (e.g., the process of block 304 of the method 300 of FIG. 3). In the illustrated embodiment, slicing of the object geometry is performed in the spatial domain, e.g., each grayscale slice 508 corresponds to a different spatial (e.g., vertical) location along the object. FIG. 5G illustrates a plurality of binary slices 510 generated from the grayscale slices 508 using a binarization function in accordance with the techniques described herein (e.g., the process of block 306 of the method 300 of FIG. 3). Each binary slice 510 is generated from a corresponding grayscale slice 508 and can represent the energy dosage and/or degree of curing to form an individual object layer at a particular spatial (e.g., vertical) location along the object. The binary slices 510 can thus collectively represent a plurality of different layers of the object to be fabricated in a layer-by-layer additive manufacturing process, e.g., an energy pattern corresponding to the first binary slice 510 is used to form a first object layer, an energy pattern corresponding to the second binary slice 510 is used to form a second, subsequent object layer, etc. The cumulative geometry of the stacked object layers fabricated from the binary slices 510 can approximate the initial rounded geometry of the object due to statistical regression effects, as well as smoothing phenomena during the additive manufacturing process and/or post-processing.

FIG. 5H illustrates a process for producing object slices in the temporal domain with improved fidelity. As shown in FIG. 5H, an individual grayscale slice 508 can be used to generate a plurality of binary slices 510. The binary slices 510 can represent the energy dosages and/or degree of curing to be applied at different times to form a single layer 512 of the object, e.g., an energy pattern corresponding to the first binary slice 510 is applied to the precursor material at a first time step, an energy pattern corresponding to the second binary slice 510 is applied to the precursor material at a second, subsequent time step, etc. The time steps may each have the same duration or may have different durations. The cumulative energy dosages over time that are applied to the object layer 512 can approximate the initial rounded geometry of the object due to statistical regression effects, as well as smoothing phenomena during the additive manufacturing process and/or post-processing.

The spatial domain and temporal domain techniques described herein may be used separately or together to produce additively manufactured objects with improved fidelity. For example, a plurality of binary slices can be generated for an object, where a first set of the binary slices represent different layers of the object (spatial domain slicing), and a second set of the binary slices represent different energy patterns for one or more individual layers of the object (temporal domain slicing).

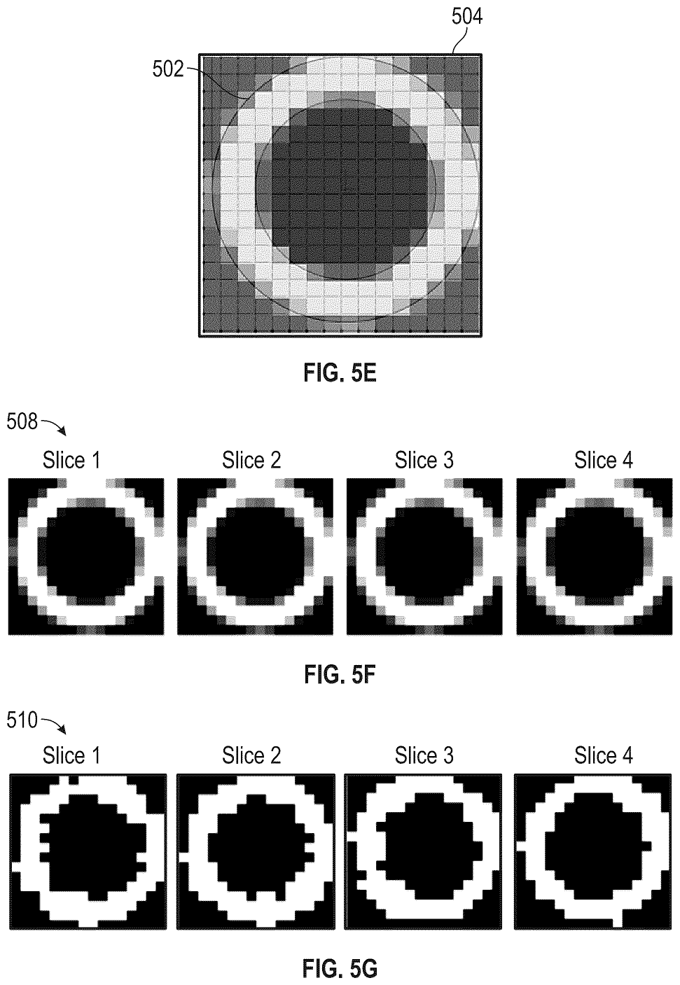

FIGS. 6A-6D illustrate example object slices for a dental appliance to be fabricated via an additive manufacturing process, in accordance with embodiments of the present technology. FIG. 6A is a cross-section 600 of the geometry of the dental appliance. As shown in FIG. 6A, the appliance geometry includes complex shapes and fine details that can be significant to the proper fit and function of the dental appliance.

FIG. 6B illustrates a plurality of binary slices 604 generated by direct conversion of the appliance geometry into the resolution of the additive manufacturing system using a hard binarization threshold (the slices 604 correspond to the region 602 shown in FIG. 6A). This process may result in significant loss of fidelity, e.g., the size and shapes of the slices 604 may deviate from the initial appliance geometry by amounts that exceed the manufacturing tolerances for the dental appliance.

FIG. 6C illustrates a plurality of grayscale slices 606 generated from the appliance geometry using a grayscaling function in accordance with the techniques described herein (e.g., the process of block 304 of the method 300 of FIG. 3), and FIG. 6D illustrates a plurality of binary slices 608 generated from the grayscale slices 606 using a binarization function in accordance with the techniques described herein (e.g., the process of block 306 of the method 300 of FIG. 3) (the grayscale slices 606 and binary slices 608 correspond to the region 602 shown in FIG. 6A). As shown in FIG. 6D, the binary slices 608 resulting from this process can provide significantly improved fidelity to the initial appliance geometry, thereby reducing the likelihood that the fabricated dental appliance will exhibit deviations that exceed the manufacturing tolerances.

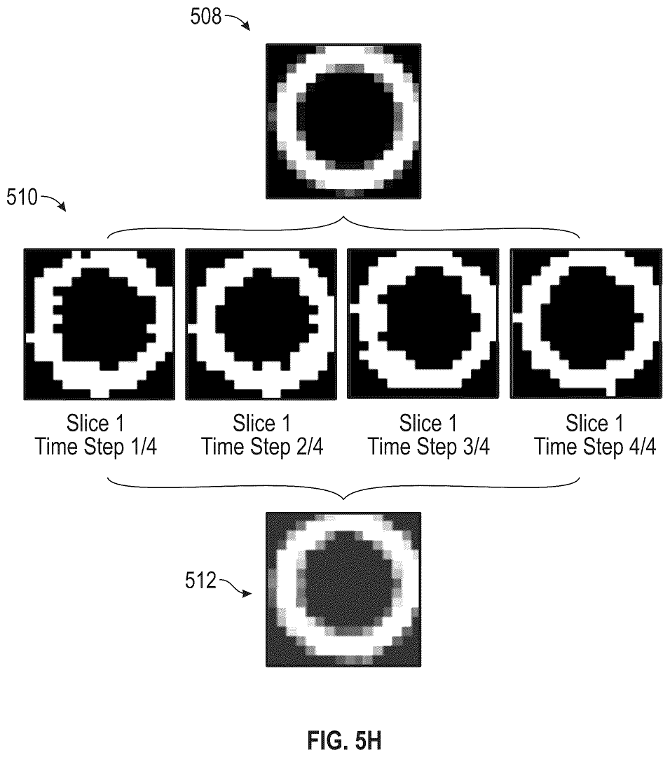

FIGS. 7A-7C illustrate example object slices for an additive manufacturing process, in accordance with embodiments of the present technology. The original object geometry in the embodiments of FIGS. 7A-7C is an angled beam. FIG. 7A depicts a binary object slice 702 generated by direct conversion of the object geometry into the resolution of the additive manufacturing system using a hard binarization threshold. As shown in FIG. 7A, the binary slice 702 exhibits discontinuities along the lateral edges (“stair-stepping,” indicated by arrows) due to the limited resolution of the binary slice 702. This stair-stepping effect can cause the object to have a poor surface finish.

FIG. 7B illustrates a grayscale slice 704 for the angled beam generated using a grayscaling function in accordance with the techniques described herein (e.g., the process of block 304 of the method 300 of FIG. 3), and FIG. 7C illustrates two binary slices 706 generated from the grayscale slice 704 using a binarization function in accordance with the techniques described herein (e.g., the process of block 306 of the method 300 of FIG. 3). As shown in FIG. 7C, the binary slices 706 resulting from this process can reduce the stair-stepping effect, thereby producing an object with a smoother surface finish.

In some embodiments, the probabilistic discretization techniques described herein are applied only to certain portions of the object geometry. For example, loss of fidelity may be a more significant issue for the surfaces and/or edges of the object, since these are the locations where large variations in geometry across neighboring voxels are likely to occur. The interior portions of the object may generally be uniformly cured and thus may not be as susceptible to fidelity issues. Similarly, the empty spaces surrounding the object may generally be uniformly uncured and thus may also be less affected by fidelity issues. Accordingly, the speed of object slice generation may be increased and/or optimized by only applying probabilistic discretization to locations where loss of fidelity is a significant concern (e.g., edges and/or surfaces), whereas the remaining portions of the object can be downsampled and discretized via faster and/or simpler techniques (e.g., hard threshold binarization).

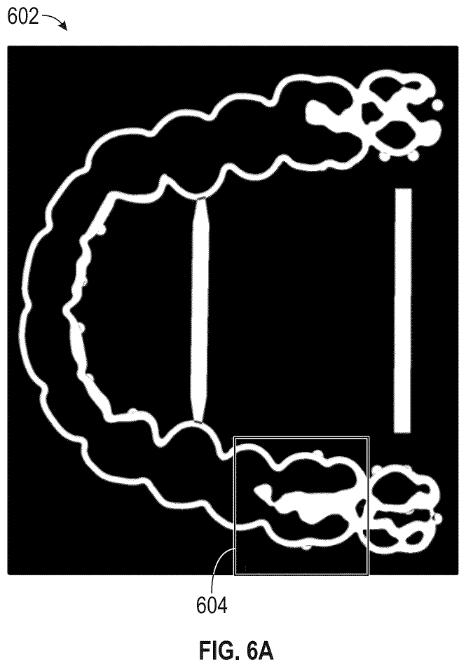

FIG. 8 illustrates an example of object contours 800 that can be used to identify regions of interest for probabilistic discretization, in accordance with embodiments of the present technology. The contours 800 can correspond to the edges and/or surfaces of the objects where fidelity issues may be a more significant concern. Thus, the contours 800 can be used as indicators to define portions of the objects where the probabilistic discretization algorithm should or should not be applied, e.g., probabilistic discretization is applied to all voxels within X distance of the contours, and is not applied to any remaining voxels.

In some embodiments, discretization of an object geometry can be used to achieve features smaller than the optical resolution of the additive manufacturing system. For example, if the unit size (e.g., pixel or voxel size) of the object slices is smaller than the optical resolution of the energy source of the additive manufacturing system (e.g., the spot size of the laser beam), an energy exposure at a given x-y coordinate location in the material may affect not only the z-resolution but also neighboring areas in the x- and/or y-directions. Thus, a sequence of binary pixels/voxels having a pixel/voxel size smaller than the optical resolution (referred to herein as “sub-optical resolution”) can be used to create variations in the applied energy dosages and/or degree of curing across the material, e.g., similar to what may be achieved using grayscaling-capable additive manufacturing systems. In some embodiments, the sub-optical resolution unit size is less than or equal to 50 μm, 20 μm, 10 μm, 5 μm, 2 μm, or 1 μm.

For example, in embodiments where the additive manufacturing system is a laser scanning system (e.g., a SLA or SLS system), the optical resolution can be defined by the size of a single focused laser beam at a target position (e.g., the diffraction-limited optical “pixel/spot” of the system), and the on time of the laser (modulation) can be used to determine the start and end of an exposed line scanned by the laser. If the modulation frequency of the laser is set to be higher than the target optical resolution (e.g., modulating in 5 μm increments with a laser spot size of 20 μm), this means that a binary pixel in the pixel space affects neighboring areas when looking at the energy distribution produced by applying the laser to the corresponding location in the material. Therefore, a sub-optical resolution pixel sequence can allow for variable energy dosages (e.g., grayscaling) within the 2D scan field of a given object layer. In some embodiments, energy patterns are constructed by superimposing laser pulses on a grid with a spacing below the spot size of the laser. This approach allows for high scan speeds, as the digital modulation of lasers can be very fast, as well as the creation of complex energy patterns with varying energy dosages at different spatial locations.

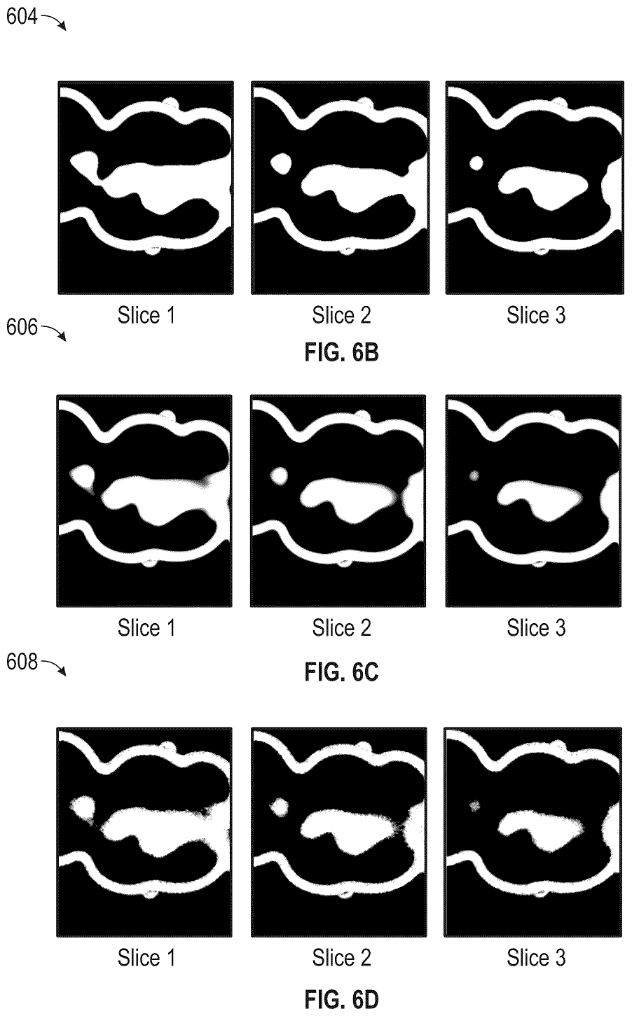

FIGS. 9A-9D illustrate the use of binary object slices 900a-900d with sub-optical resolution to achieve variable energy dosages, in accordance with embodiments of the present technology. Referring first to FIG. 9A, the binary slice 900a has individual pixels 902 that are smaller than the size of an energy beam spot 904 produced by an energy source of an additive manufacturing system. Thus, the single pixel 902 of the binary slice 900a shown in FIG. 9A will actually result in energy exposure over a larger surface area delineated by the size of the spot 904. Referring next to FIG. 9B, the binary slice 900b includes two pixels 902 that are in close proximity to each other, such that the energy beam spots 904 corresponding to the pixels 902 overlap each other at an overlap region 906. Accordingly, the material at the overlap region 906 will receive a higher energy dosage compared to the material at the remaining regions 908, thereby resulting in a heterogenous degree of curing across the material.

Referring next to FIGS. 9C and 9D together, even finer variations in the applied energy dosages and/or degree of curing may be achieved by further reductions in the pixel size. For example, in the embodiment of FIG. 9C, the binary slice 900c includes four consecutive pixels 910 arranged in a straight line, resulting in overlapping energy beam spots 904 that produce four different energy dosages and/or degrees of curing in the material: (1) a first energy dosage/degree of curing at regions exposed to a single spot 904, (2) a second energy dosage/degree of curing at regions exposed to two overlapping spots 904, (3) a third energy dosage/degree of curing at regions exposed to three overlapping spots 904, and (4) a fourth energy dosage/degree of curing at regions exposed to four overlapping spots 904. As shown in the binary slice 900d of FIG. 9D, the spacing between the individual pixels 910 can be varied to control the spatial distribution of the variable energy dosages and/or degrees of curing, e.g., the region of the material that receives the first energy dosage/degree of curing is larger due to the gap between the first pixel 910 and the other three pixels 910 in the line.

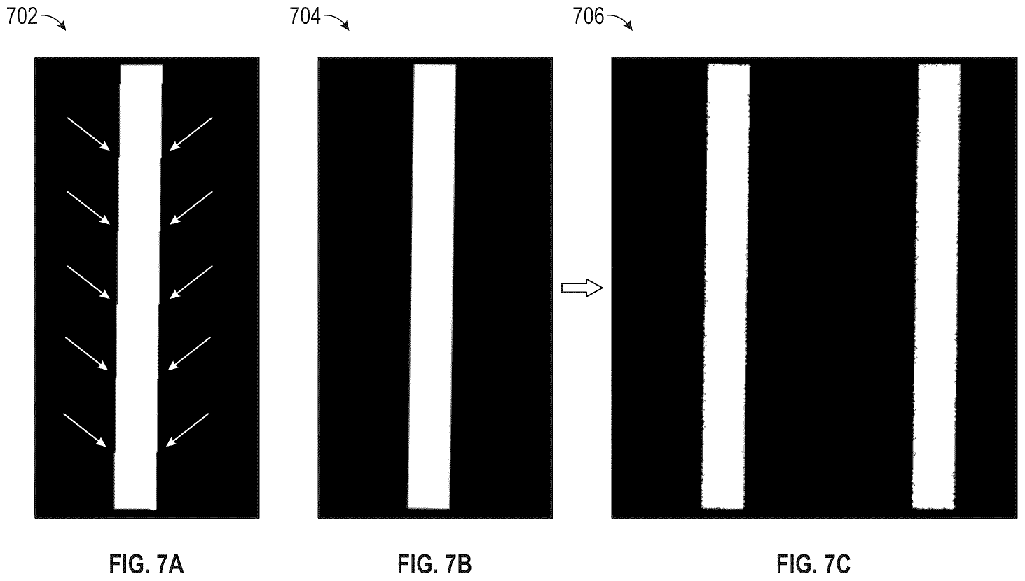

FIGS. 10A-10C illustrate the use of binary slices with sub-optical resolution to reduce stair-stepping effects, in accordance with embodiments of the present technology. Referring first to FIG. 10A, a completely vertical or horizontal line 1000 may be converted to a binary slice 1002 without stair-stepping effects. However, as shown in FIG. 10B, when an angled line 1004 is converted to a binary slice 1006, the result may be a series of pixels with discontinuities due to the limited resolution of the binary slice 1006. As shown in FIG. 10C, the stair-stepping effect may be reduced by using the grayscaled energy distribution depicted in slice 1008 to smooth out the discontinuities in the converted angled line 1004. The grayscaling effect depicted in FIG. 10C may be achieved using a binary slice having a sub-optical resolution to achieve variable energy distributions locally, e.g., as previously discussed with respect to FIGS. 9A-9D.

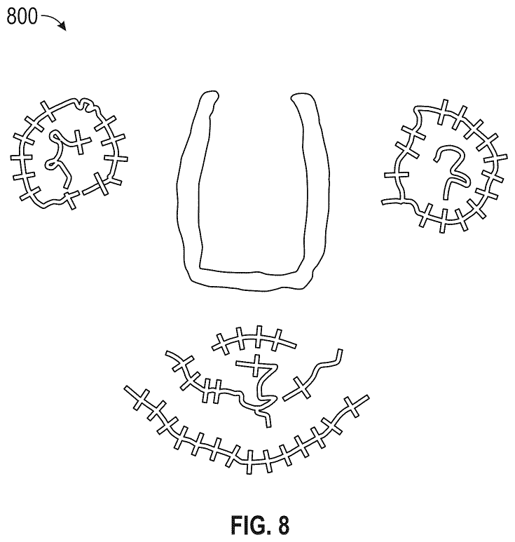

FIGS. 11A and 11B illustrate the use of binary slices with sub-optical resolution to produce features below the optical resolution limit, in accordance with embodiments of the present technology. FIG. 11A illustrates an energy pattern 1100a produced from a binary slice having a pixel size (represented by grid 1102) that is equal to the optical resolution (e.g., spot size) of the energy source of the additive manufacturing system. As shown in FIG. 11A, the laser spot can be scanned across the material to produce a series of lines 1104 defining the object geometry, where the height of each line 1104 is determined by the spot size of the laser and the length of the line 1104 is determined by the laser modulation. When the pixel size of the binary slice is set to be equal to the spot size of the laser, the minimum feature size of the object is also limited to the spot size.

FIG. 11B illustrates an energy pattern 1100b produced from a binary slice having a pixel size (represented by grid 1112) that is smaller the optical resolution of the energy source of the additive manufacturing system. In the embodiment of FIG. 11B, the horizontal pixel size of the binary slice is smaller than the spot size of the laser. This may be achieved, for example, by modulating the laser at a higher frequency than the optical resolution of the system. Thus, the object geometry produced by the series of lines 1114 can have controlled contours and feature sizes that are smaller than the spot size of the laser.

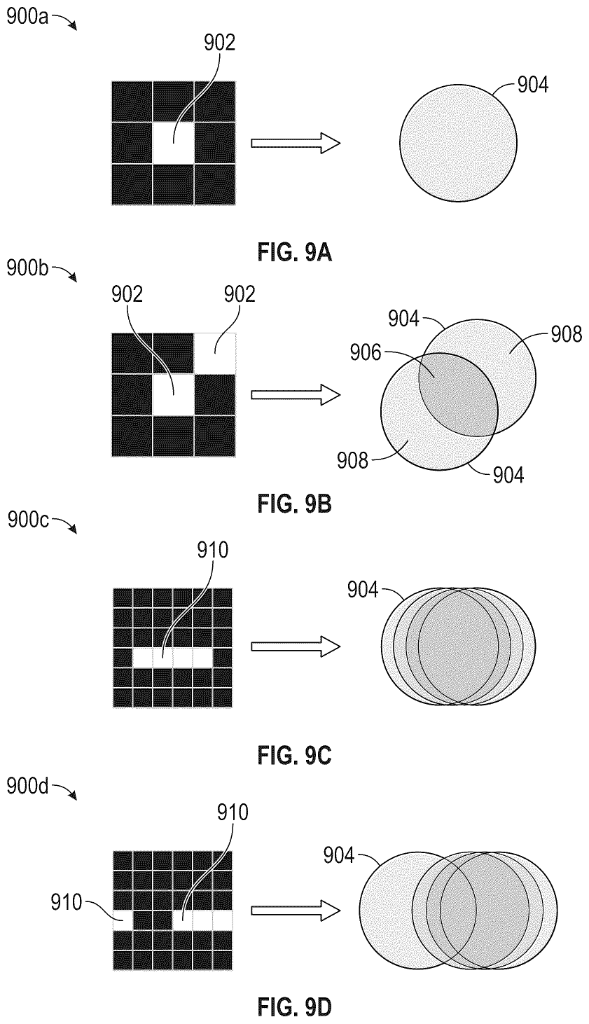

FIGS. 12A-12C illustrate the use of binary slices with sub-optical resolution to produce gradients in energy distribution and curing, in accordance with embodiments of the present technology. Specifically FIG. 12A illustrates a binary slice 1200 for an object, FIG. 12B illustrates a simulated energy distribution 1202 resulting from the binary slice 1200, and FIG. 12C illustrates a printed object 1204 produced from the binary slice 1200. Referring first to FIG. 12A, the binary slice includes a gradual reduction in pixel density over a circular area using a stochastic distribution. As shown in FIG. 12B, the variations in pixel density can result in an energy gradient over the circular area, e.g., the energy dosage gradually decreases in a radial direction from the center of the circle to the edge of the circle. As shown in FIG. 12C, the energy gradient can produce a corresponding curing gradient, e.g., the degree of curing of the material gradually decreases in a radial direction from the center of the circle to the edge of the circle, resulting in a domed structure.

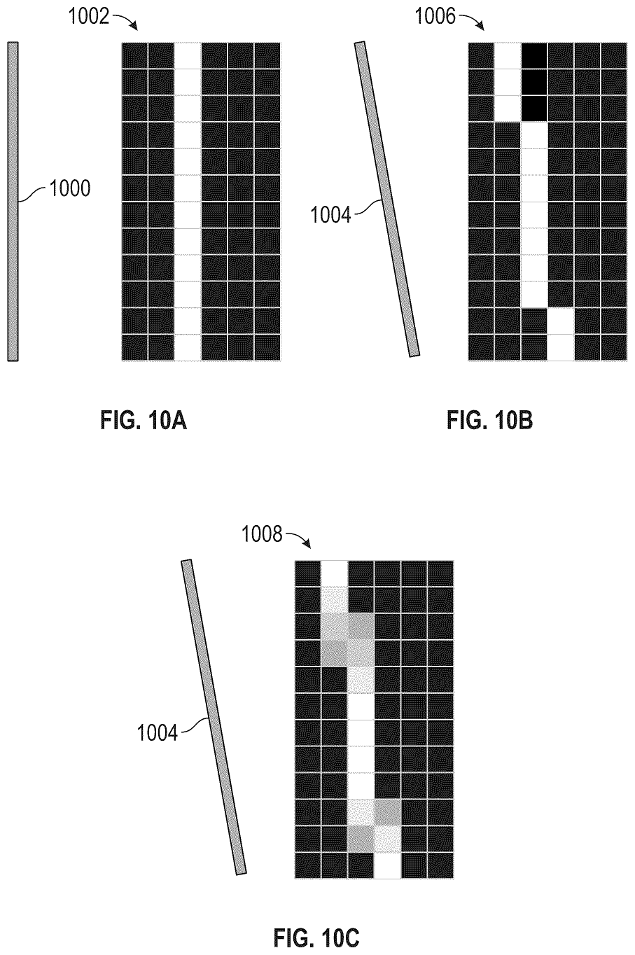

FIG. 13 illustrates a height map 1302 of an object with microscale surface features and a corresponding grayscale slice 1304 for additive manufacturing of the object, in accordance with embodiments of the present technology. In the illustrated example, the surface height variations of the object are smaller than the minimum layer thickness of the additive manufacturing system. However, the sub-optical resolution techniques herein can be used to generate binary slices that create variations in energy distribution and curing to produce a printed object with the microscale surface height variations. Specifically, the height map 1302 can be converted to a set of grayscale slices 1304 in which different grayscale values correlate to different surface heights, and the grayscale slices 1304 can then be used to generate binary slices in accordance with the probabilistic discretization methods described herein.

Other applications for binary slices with sub-optical resolution for producing spatial variations in energy distribution and curing include, for example, fabrication of objects with heterogenous properties (e.g., to provide local control over modulus, strength, elongation, etc.), fabrication of support structures with a selectively weakened interface with the object for easier removal, localized manipulation of polymerization kinetics within a printed object, etc. In embodiments where an additive manufacturing system with multiple overlapping energy sources is used (e.g., multiple DLP projectors (e.g., UV or IR), a DLP projector and a laser (e.g., UV or IR)), the techniques herein can be applied to provide improved control over the energy dosages applied to the overlap regions, which may be important for better printing quality.

In some embodiments, for example, spatial variations in energy distribution and curing within the interior of an object (e.g., regions that are intended to be completely cured) may be used to control the local mechanical properties of the object. Surprisingly, in some instances, binary slices produced using non-white grayscale values (e.g., approximately 80% gray) for voxels within the interior of the object have been found to produce improvements in strength and elongation at break. Without wishing to be bound by theory, it is hypothesized that this effect is attributable to enhanced diffusion of lower molecular weight components within the material.

Although certain embodiments of the sub-optical resolution techniques herein are described in connection with laser scanning systems, these techniques may be implemented in connection with other types of additive manufacturing systems, such as projector systems (e.g., DLP systems). For example, sub-optical resolution in projector systems may be achieved through sub-pixelization techniques, such as alternating the images output by the projector and/or sub-pixel shifting.

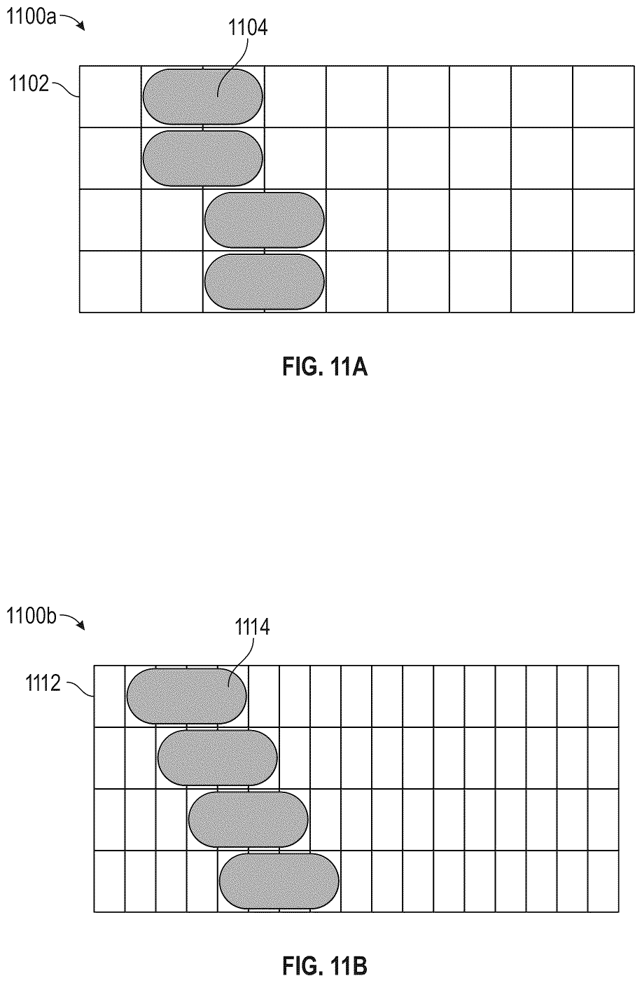

FIG. 14 illustrates a binary slice 1400 with an overlaid object cross-section 1402, in accordance with embodiments of the present technology. The object cross-section 1402 can be converted into the resolution of the additive manufacturing system (represented by grid 1404) in accordance with the probabilistic discretization techniques described herein. In some embodiments, when determining the binary value for a particular pixel, the impact of adjacent pixels is also considered. For instance, as shown in FIG. 14, certain regions 1406 of the object are set to be black pixels (no energy applied) because it is expected that light scattering and/or overcuring effects from energy applied to the neighboring white pixels will result in some curing of those regions 1406 during the additive manufacturing process, thereby producing the intended object geometry. This approach can be implemented by, for example, applying a convolutional neural network layer with a sharpening kernel to the object cross-section 1402. The resulting binary slice 1400 may be sharper, more “ragged,” and sparse, but can still produce a printed object with high fidelity to the intended geometry. Alternatively or in combination, other parameters may be considered when binarizing the object geometry, such as print orientation, island detection and removal, etc.

Although certain embodiments of the probabilistic discretization techniques herein are described in terms of curing of a material, this is not intended to be limiting, and the techniques herein are applicable to objects formed through other techniques such as melting, sintering, fusing, etc. Moreover, although certain embodiments are described with respect to individual object layers and layer-by-layer additive manufacturing, the present technology can be modified for use with other types of additive manufacturing processes, such as continuous additive manufacturing processes (e.g., CLIP) and volumetric additive manufacturing processes.

Moreover, although certain embodiments of the probabilistic discretization techniques herein are described in terms of binary slices, this is not intended to be limiting, and the present technology can be applied to generation of slices with more than two different energy dosage (e.g., three, four, five, or more different energy dosages). Such slices may be referred to herein as “discretized” slices with “discretized” voxels, and may be generated using a “discretization function” that converts grayscale values into discretized values. Accordingly, any description herein referring to “binary slices” and “binarizing functions” can be modified as appropriate for use with discretized slices and discretization functions.

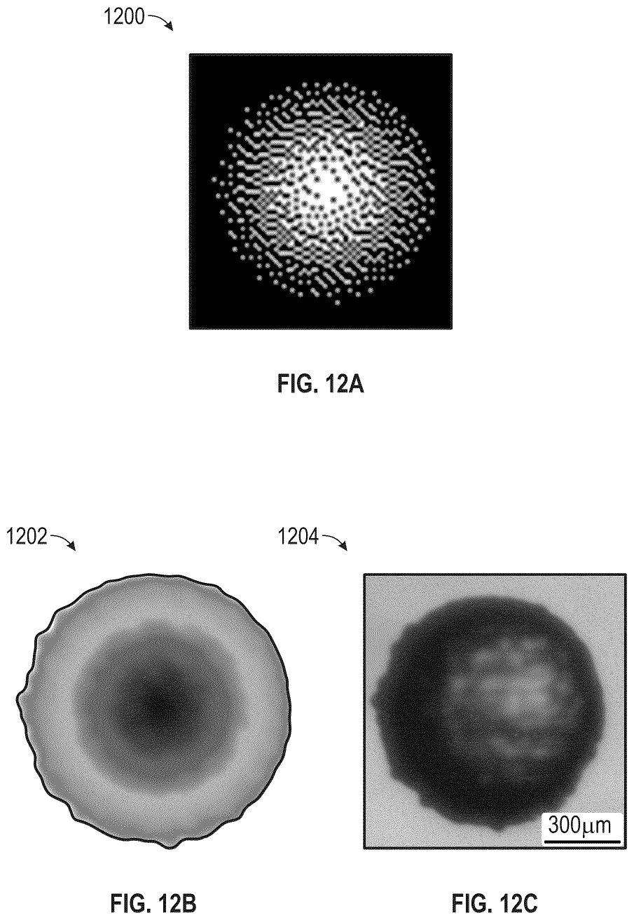

FIG. 15 is a flow diagram illustrating a method 1500 for generating object slices for additive manufacturing, in accordance with embodiments of the present technology. The method 1500 can be used to produce many different types of additively manufactured objects, such as any of the dental appliances described herein. In some embodiments, some or all of the processes of the method 1500 are implemented as computer-readable instructions (e.g., program code) that are configured to be executed by one or more processors of a computing device (e.g., an appliance design system and/or a controller of an additive manufacturing system).

The method 1500 can begin at block 1502 with receiving a 3D digital representation of an object to be fabricated via an additive manufacturing process. The 3D digital representation can be a 3D digital model depicting the 3D geometry of the object, such as a surface model, mesh model, non-parametric model, parametric model, etc. The 3D digital representation can be provided in any suitable file format, such as a CAD file, STL file, OBJ file, AMF file, 3MF file, etc. In some embodiments, the 3D digital representation is generated in a high resolution, which may correspond to the resolution of the software application used to produce the 3D digital representation (e.g., CAD software).

At block 1504, the method 1500 can include generating a plurality of grayscale slices, based on the 3D digital representation. The grayscale slices can correspond to a plurality of 2D cross-sections (e.g., layers) of the 3D digital representation that are taken at different vertical locations along the 3D digital representation, with the spacing between the vertical locations corresponding to the height of the object cross-sections. Each grayscale slice can include a plurality of grayscale units, such as grayscale voxels (e.g., voxels having a plurality of different possible grayscale values between black and white). The size of the grayscale voxels can correlate to the resolution of the additive manufacturing system, which may be lower than the resolution of the 3D digital representation as discussed elsewhere herein.

The range of grayscale values for the grayscale voxels can be a continuous range of grayscale values or can be a range composed of three or more discrete grayscale values (e.g., 8-bit grayscale having 256 possible grayscale values). In some embodiments, the grayscale voxels correlate to variable energy dosages and/or degrees of curing that would be used to form the object cross-section, if an additive manufacturing system with grayscaling capabilities were used. Alternatively or in combination, the grayscale voxels can correlate to a “density” of the object at each voxel of the object cross-section, e.g., the grayscale value is black if the voxel is empty space, the grayscale value is white if the voxel is completely occupied by the object, the grayscale value is 50% gray if 50% of the volume of the voxel is occupied by the object and the remaining 50% of the volume is occupied by empty space, the grayscale value is 25% gray if 25% of the volume of the voxel is occupied by the object and the remaining 75% of the volume is occupied by empty space, etc.

At block 1506, the method 1500 can continue with generating a plurality of discretized slices based on the grayscale slices. Each discretized slice can include a plurality of discretized units, such as discretized voxels. The discretized voxels can have a smaller range of possible values compared to the grayscale voxels, e.g., the grayscale voxels may be high resolution grayscale voxels such as 8-bit grayscale voxels having 256 possible grayscale values, while the discretized voxels may be low resolution grayscale voxels such as 2-bit grayscale voxels having 4 possible grayscale values. The discretized voxels can represent discretized energy dosages to be applied to the precursor material to form the object cross-section, e.g., black voxels can represent locations where no energy is applied (e.g., 0% dosage), white voxels can represent locations where a maximum energy dosage is applied (e.g., 100% dosage), and gray voxels can represent locations where intermediate energy dosages are applied (e.g., 33% or 66% dosages, for 2-bit grayscale). Alternatively or in combination, the discretized voxels can represent discretized degrees of curing of the material, e.g., black voxels indicate that no curing should occur at that particular location (e.g., 0% curing), white voxels indicate that maximum curing should occur at that particular location (e.g., 100% curing), and gray voxels indicate that intermediate curing should occur at that particular location (e.g., 33% or 66% curing, for 2-bit grayscale). The size of the discretized voxels can correlate to the resolution of the additive manufacturing system, and may be the same as the size of the grayscale voxels of the grayscale slices.

In some embodiments, each discretized slice is generated from a corresponding grayscale slice. The discretized slices can collectively represent a plurality of object cross-sections at different vertical locations along the object. Optionally, at least some of the discretized slices can represent different energy patterns to be applied at the same vertical location of the object. Each discretized voxel for a discretized slice can be generated based on a corresponding grayscale voxel of the corresponding grayscale slice. The corresponding grayscale voxel can be the voxel at the same location in the grayscale slice as the location of the discretized voxel in the discretized slice, e., the grayscale voxel at position (0, 0) in the grayscale slice is used to generate the discretized voxel at position (0, 0) in the discretized slice, the grayscale voxel at position (1, 0) in the grayscale slice is used to generate the discretized voxel at position (1, 0) in the discretized slice, etc.

In some embodiments, the discretized voxel is generated by applying a discretizing function to the grayscale voxel to convert the grayscale value of the grayscale voxel to a discretized value for the discretized voxel. The discretizing function can use a probability distribution to determine the discretized value, where the probability distribution that is sampled to select the discretized value is based on the grayscale value. The discretizing function can be a fully stochastic function, in that the discretized value is produced by purely random sampling of the probability distribution. Alternatively, the discretizing function can be a partially stochastic or non-stochastic function, in that there may be weighting, periodic patterning, or other non-randomized approaches used to determine the discretized value.

The discretizing function can output the discretized slices in any suitable file format, such as VTK, VTI, PNG, BMP, DICOM, etc. Optionally, the discretized slices may be output as images that are subsequently converted to tensors. In some embodiments, a first tensor is used to represent a 3D array containing grayscale values corresponding to the volume ratio of the designed object in voxel space, and a second tensor is used to represent a 3D array containing discretized values after the discretizing function has been applied to the grayscale values. The use of tensors or 3D arrays for processing may be significantly more efficient than processing of images, e.g., due to more streamlined operations, better memory management, and faster computations. Accordingly, any reference herein to processes performed on images and/or slices can also be applied to processes performed on tensors or 3D arrays generated from such images and/or slices.

At block 1508, the method 1500 can include outputting instructions for fabricating the object via an additive manufacturing process, based on the discretized slices. As described herein, the discretized voxels of the binary slices can correspond to the discretized energy dosages to be applied to various spatial locations of the precursor material and/or can indicate appropriate degree of curing of the material at various locations. Accordingly, the discretized slices can be used to generate instructions for controlling the additive manufacturing system (e.g., energy intensity, locations where energy is applied) to fabricate the object, with each discretized slice being used to produce instructions for an individual layer of the object.

At block 1510, the method 1500 can include fabricating the object via the additive manufacturing process. Examples of additive manufacturing processes that may be used include DLP, SLA, SLS inkjet printing, binder jetting, continuous liquid interface production, two-photon induced photopolymerization, and volumetric additive manufacturing. The additive manufacturing process can include controlling an energy source to apply energy (e.g., light) to selected locations of a precursor material (e.g., a polymerizable resin) to cause the material to become cured, polymerized, melted, sintered, fused, and/or otherwise solidified to form the object in a layer-by-layer manner. For example, the energy source can be a light engine, a projector, or a scanning laser system.

In some embodiments, certain chemical and/or physical phenomena that may occur during the additive manufacturing process can cause the actual object geometry to become smoothed compared to the geometry of the discretized slices, such as light scattering, overcuring, surface tension of the precursor material (e.g., resin), tracking of the precursor material, and/or frontal polymerization. Moreover, the vertical stacking of multiple object layers can result in smoothing in the vertical direction and/or in the cumulative object geometry becoming closer to the designed geometry due to statistical regression effects. Thus, higher object fidelity can be achieved even though discretized slices are used.

At block 1512, the method 1500 can optionally include performing post-processing of the object. Post-processing may include, for example, removing excess material, post-curing, annealing, cleaning, trimming of support structures, and/or surface modifications to the object. In some embodiments, post-processing may produce further smoothing of the object geometry. For instance, residual material remaining on the object surface after centrifugation may become incorporated into the object during post-curing, thus providing an additional smoothing effect that can further enhance the fidelity of the object geometry to the initial design.

The method 1500 illustrated in FIG. 15 can be modified in many different ways. For example, although the above processes of the method 1500 are described with respect to a single object, the method 1500 can be used to sequentially or concurrently design and fabricate any suitable number of objects, such as tens, hundreds, or thousands of additively manufactured objects. As another example, the ordering of the processes shown in FIG. 15 can be varied. Some of the processes of the method 1500 can be omitted (e.g., the process of blocks 1510 and/or block 1512), and/or the method 1500 can include additional processes not shown in FIG. 15.

Moreover, in some embodiments, the processes of the method 1500 may not be applied to the entire object geometry concurrently. Instead, a divide-and-conquer approach may be used, e.g., subregions of the object geometry can be grayscaled and discretized individually and subsequently recombined. This approach can be advantageous for improving computational speed via parallel processing.

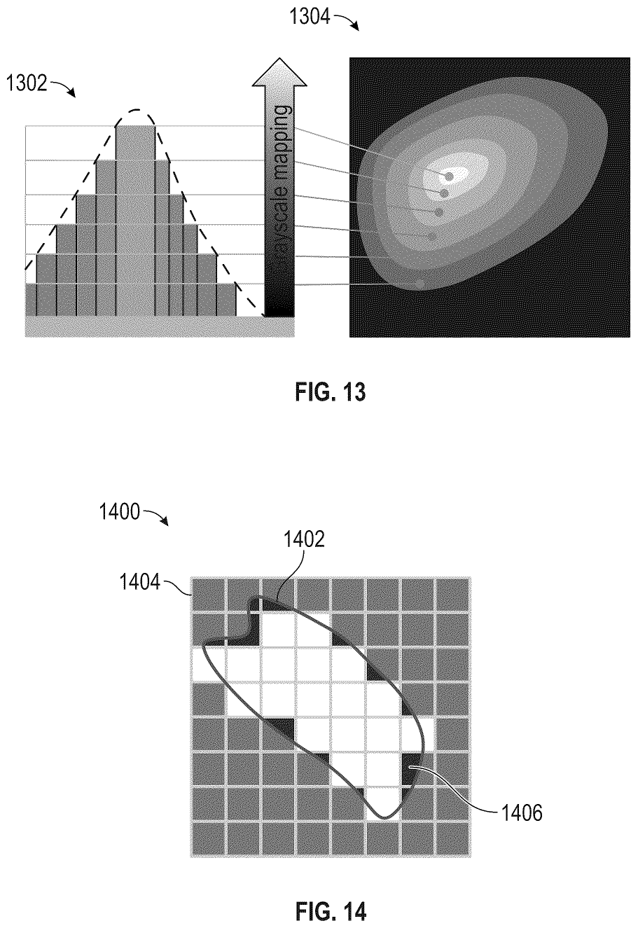

FIGS. 16A-16C illustrate representative examples of a high resolution slice and lower resolution slices that may be generated from the high resolution slice using various methods, in accordance with embodiments of the present technology. Specifically, in each of FIGS. 16A-16C, the high resolution slice is an 8-bit grayscale slice (“8-bit grayscale target”). The lower resolution slices include a binary slice generated via hard threshold binarization (“binary deterministic”), a binary slice generated via probabilistic discretization (“binary stochastic”), a 2-bit grayscale slice generated via hard threshold discretization (“2-bit grayscale deterministic”), and a 2-bit grayscale slice generated via probabilistic discretization (“2-bit grayscale stochastic”). As shown in FIGS. 16A-16C, the slices generated via probabilistic discretization provide a more accurate representation of the high resolution slice than the slices generated using the hard threshold, and with the 2-bit grayscale stochastic slice providing even more accuracy than the binary stochastic slice.

### II. Overview of Additive Manufacturing Technology

The systems, methods, and devices described herein are suitable for use with a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

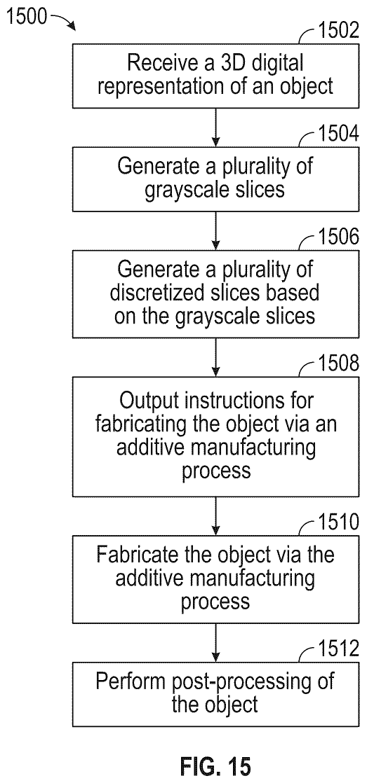

FIG. 17 is a partially schematic diagram providing a general overview of an additive manufacturing process, in accordance with embodiments of the present technology. In the embodiment of FIG. 17, an object 1702 is fabricated on a build platform 1704 from a series of cured material layers, with each layer having a geometry corresponding to a respective cross-section of the object 1702. To fabricate an individual object layer, a layer of curable material 1706 (e.g., polymerizable resin) is brought into contact with the build platform 1704 (when fabricating the first layer of the object 1702) or with the previously formed portion of the object 1702 on the build platform 1704 (when fabricating subsequent layers of the object 1702). In some embodiments, the curable material 1706 is formed on and supported by a substrate (not shown), such as a film. Energy 1708 (e.g., light) from an energy source 1710 (e.g., a laser, projector, or light engine) is then applied to the curable material 1706 to form a cured material layer 1712 on the build platform 1704 or on the object 1702. The remaining curable material 1706 can then be moved away from the build platform 1704 (e.g., by lowering the build platform 1704, by moving the build platform 1704 laterally, by raising the curable material 1706, and/or by moving the curable material 1706 laterally), thus leaving the cured material layer 1712 in place on the build platform 1704 and/or object 1702. The fabrication process can then be repeated with a fresh layer of curable material 1706 to build up the next layer of the object 1702.

The illustrated embodiment shows a “top down” configuration in which the energy source 1710 is positioned above and directs the energy 1708 down toward the build platform 1704, such that the object 1702 is formed on the upper surface of the build platform 1704. Accordingly, the build platform 1704 can be incrementally lowered relative to the energy source 1710 as successive layers of the object 1702 are formed. In other embodiments, however, the additive manufacturing process of FIG. 17 can be performed using a “bottom up” configuration in which the energy source 1710 is positioned below and directs the energy 1708 up toward the build platform 1704, such that the object 1702 is formed on the lower surface of the build platform 1704. Accordingly, the build platform 1704 can be incrementally raised relative to the energy source 1710 as successive layers of the object 1702 are formed.

Although FIG. 17 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### III. Dental Appliances and Associated Methods

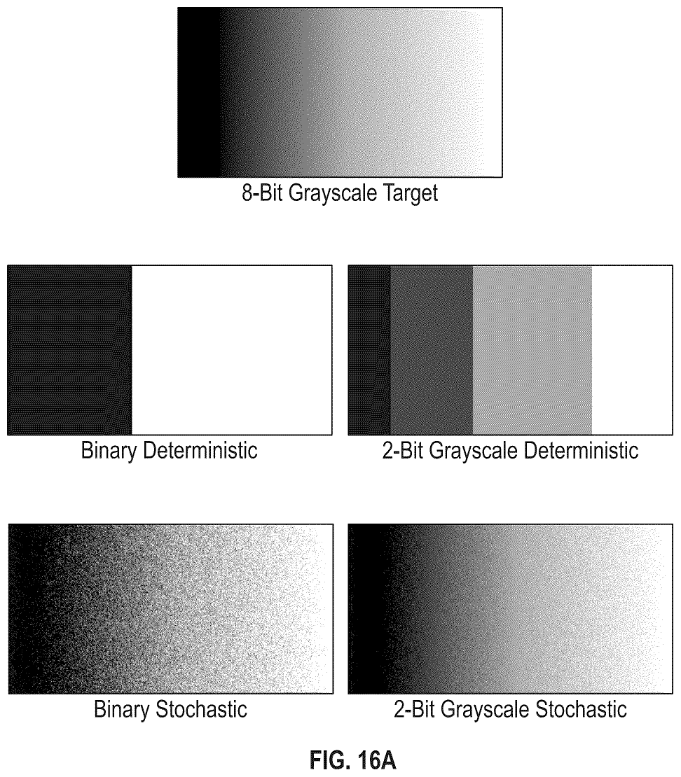

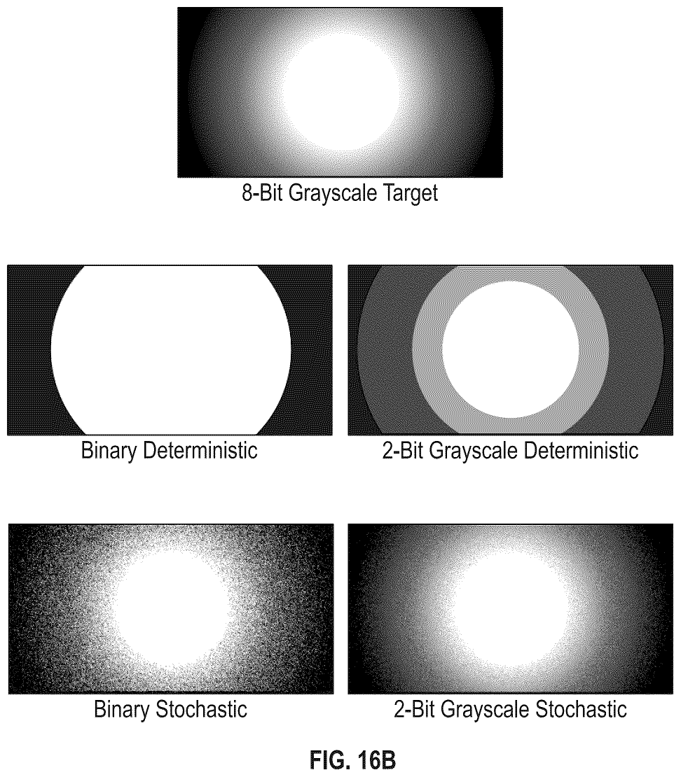

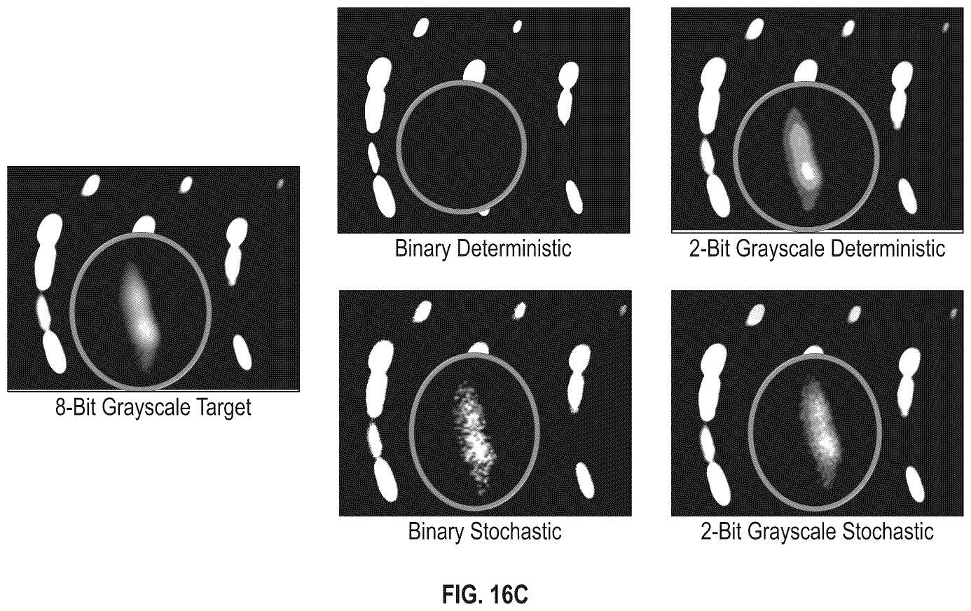

FIG. 18A illustrates a representative example of a tooth repositioning appliance 1800 configured in accordance with embodiments of the present technology. The appliance 1800 can be manufactured using any of the systems, methods, and devices described herein. The appliance 1800 (also referred to herein as an “aligner”) can be worn by a patient in order to achieve an incremental repositioning of individual teeth 1802 in the jaw. The appliance 1800 can include a shell (e.g., a continuous polymeric shell or a segmented shell) having teeth-receiving cavities that receive and resiliently reposition the teeth. The appliance 1800 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1800 can fit over all teeth present in an upper or lower jaw, or less than all of the teeth. The appliance 1800 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1800 can be a generic appliance configured to receive the teeth, but not necessarily shaped to match the topography of the patient's teeth. In some cases, only certain teeth received by the appliance 1800 are repositioned by the appliance 1800 while other teeth can provide a base or anchor region for holding the appliance 1800 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1800 in place over the teeth. In some cases, however, it may be desirable or necessary to provide individual attachments 1804 or other anchoring elements on teeth 1802 with corresponding receptacles 1806 or apertures in the appliance 1800 so that the appliance 1800 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 18B illustrates a tooth repositioning system 1810 including a plurality of appliances 1812, 1814, 1816, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1810 can include a first appliance 1812 corresponding to an initial tooth arrangement, one or more intermediate appliances 1814 corresponding to one or more intermediate arrangements, and a final appliance 1816 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 18C illustrates a method 1820 of orthodontic treatment using a plurality of appliances, in accordance with embodiments of the present technology. The method 1820 can be practiced using any of the appliances or appliance sets described herein. In block 1822, a first orthodontic appliance is applied to a patient's teeth in order to reposition the teeth from a first tooth arrangement to a second tooth arrangement. In block 1824, a second orthodontic appliance is applied to the patient's teeth in order to reposition the teeth from the second tooth arrangement to a third tooth arrangement. The method 1820 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

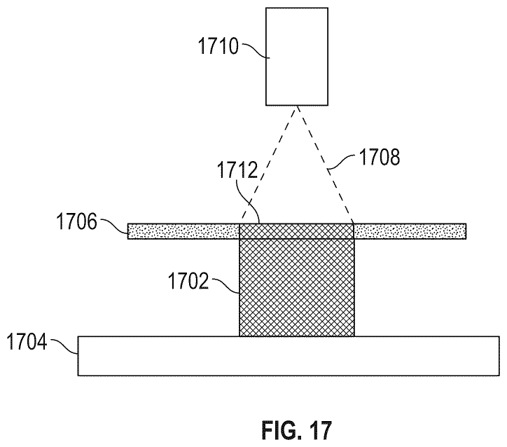

FIG. 19 illustrates a method 1900 for designing an orthodontic appliance, in accordance with embodiments of the present technology. The method 1900 can be applied to any embodiment of the orthodontic appliances described herein. Some or all of the steps of the method 1900 can be performed by any suitable data processing system or device, e.g., one or more processors configured with suitable instructions.

In block 1902, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1904, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1904 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1906, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systemes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1908, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1900 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1900 may be performed with any suitable fabrication system or device, such as the embodiments described herein. Some of the steps may be optional, e.g., the process of block 1904 can be omitted, such that the orthodontic appliance is designed based on the desired tooth movements and/or determined tooth movement path, rather than based on a force system. Moreover, the order of the steps can be varied as desired.

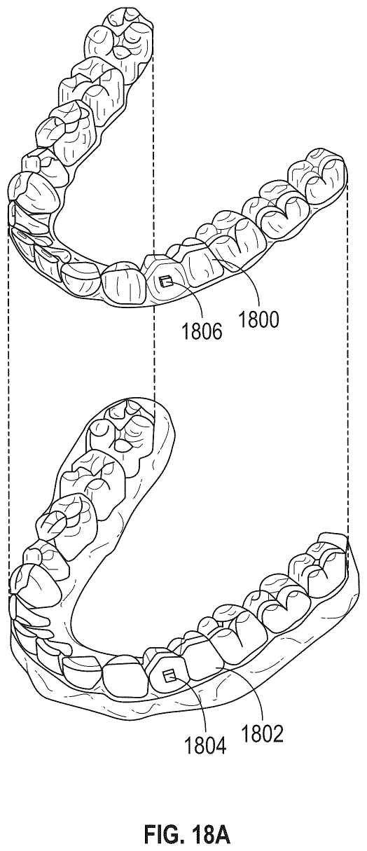

FIG. 20 illustrates a method 2000 for digitally planning an orthodontic treatment and/or design or fabrication of an appliance, in accordance with embodiments. The method 2000 can be applied to any of the treatment procedures described herein and can be performed by any suitable data processing system.

In block 2002, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 2004, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 2006, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 20, design and/or fabrication of an orthodontic appliance, and perhaps a particular orthodontic treatment, may include use of a representation of the patient's teeth (e.g., including receiving a digital representation of the patient's teeth (block 2002)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The present technology is further illustrated by the following non-limiting example.

### Example 1: Stochastic Discretization of Object Slices for Additive Manufacturing

This example describes the characterization of additively manufactured objects fabricated based on (1) object slices generated via conventional hard binarization (“traditional”) and (2) object slices generated via the stochastic discretization techniques described herein (“stochastic”).

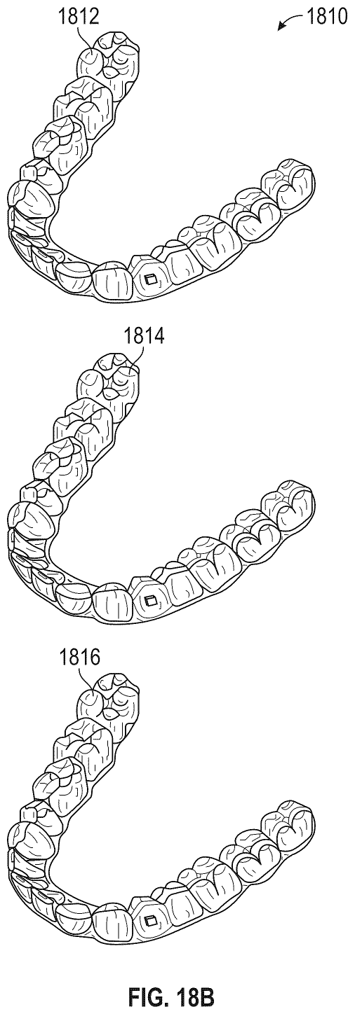

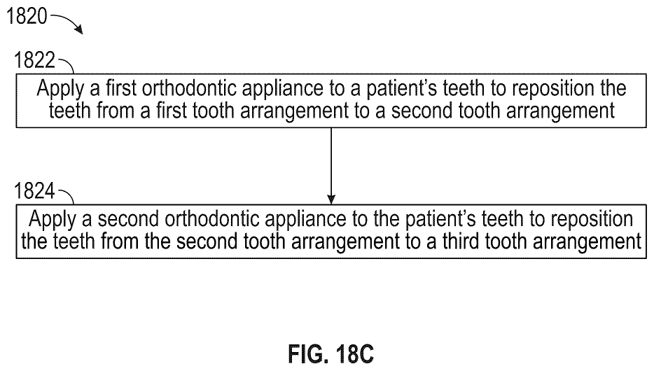

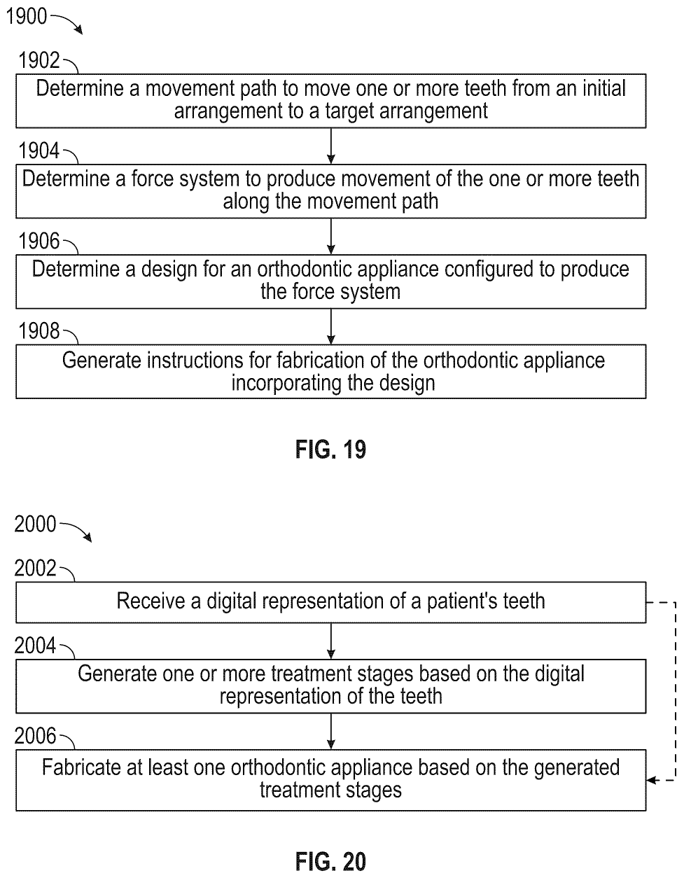

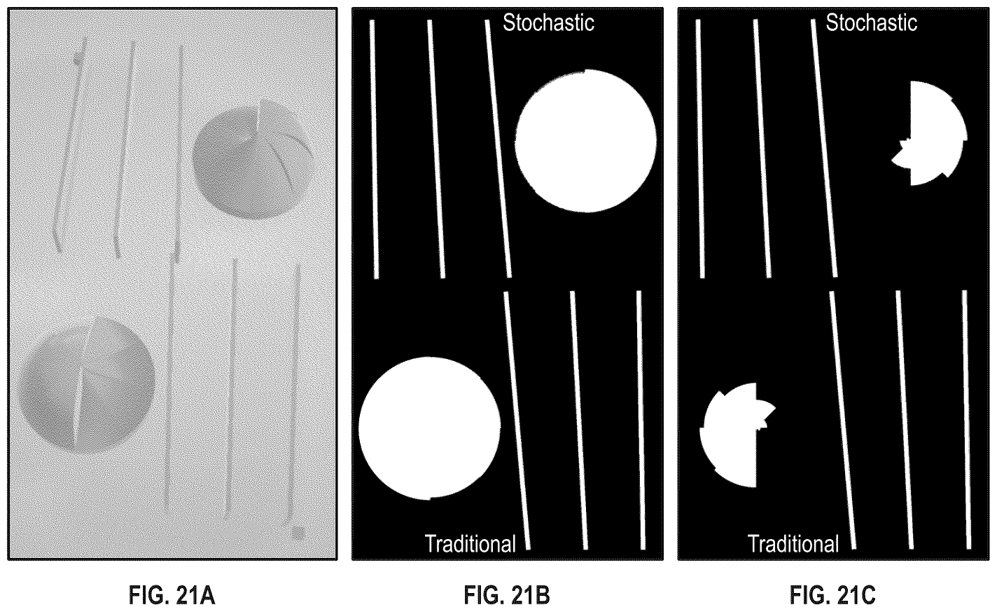

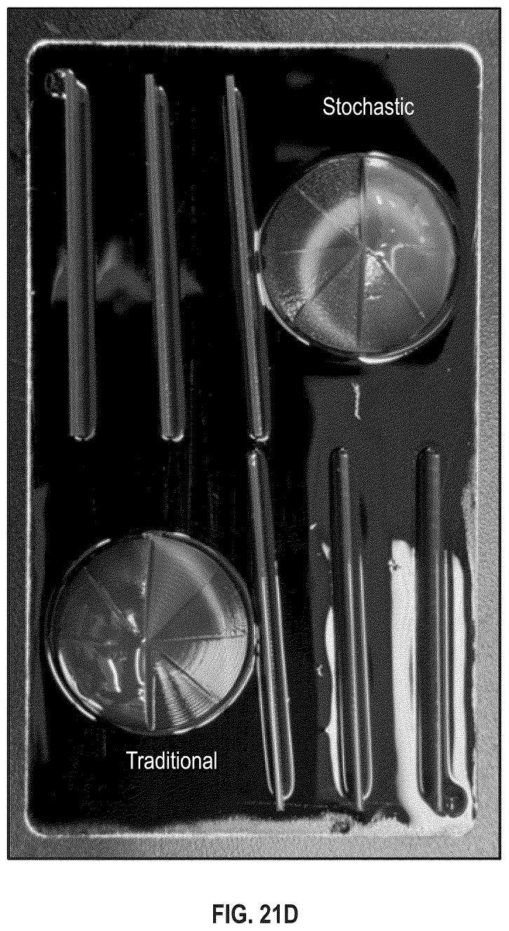

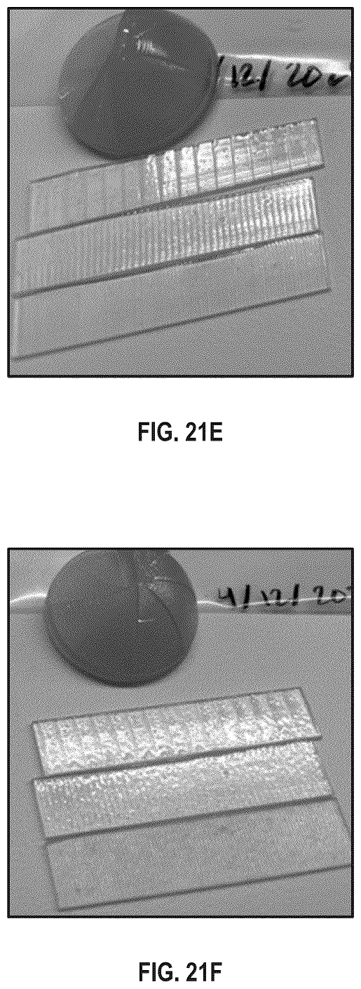

FIG. 21A shows a 3D digital representation of a coupon set for additive manufacturing. The coupons included a curved surface coupon and three strips tilted at 1, 3, and 5 degrees relative to vertical. FIGS. 21B and 21C show binary slices for the coupon set generated using conventional hard binarization (bottom) and using stochastic discretization (top) (FIG. 21B shows slice number 30 and FIG. 21C shows slice number 90).

FIG. 21D is a photograph of the coupon set after additive manufacturing and post-processing, FIG. 21E is a photograph of the coupons fabricated using the traditional slices, and FIG. 21F is a photograph of the coupons fabricated using the stochastic slices. The coupons were fabricated using a Caligma 3D printer (Cubicure GmbH). The coupons were then post-cured for 5 minutes with 365 nm, 385 nm, and 405 nm LEDs at approximately 100 mW/cm²; no solvent wash was performed before post-curing. The coupons fabricated using the traditional slices had more pronounced steps in the x-y direction, while the coupons fabricated using the stochastic slices had a rougher surface texture.

FIGS. 21G and 21H are graphs illustrating the surface geometry of the 1-degree tilted strips fabricated using the traditional slices (FIG. 21G) and the stochastic slices (FIG. 21H) (dotted lines show the actual surface geometry, dashed lines show the optimized surface geometry). The y-direction corresponds to the longitudinal axis of the strips and the z-direction represents the surface height. As shown in FIG. 21G, the strip fabricated using the traditional slices exhibited large vertical drops indicative of a one-pixel shift in the x-y direction. As shown in FIG. 21H, the strip fabricated using the stochastic slices had less pronounced drops. The Ra value of the strip fabricated using the stochastic slices was similar to the Ra value of the strip fabricated using the conventional slices, but the Rz value was significantly reduced. These results show that the stochastic slices can reduce the macroscopic shift in the x-y plane over the length of a printed object, especially for objects that do not undergo a solvent wash during post-processing.

### Example 2: Improvements in Mechanical Properties from Stochastic Discretization

This example describes the mechanical characterization of additively manufactured objects fabricated based on object slices generated via the stochastic discretization techniques described herein.

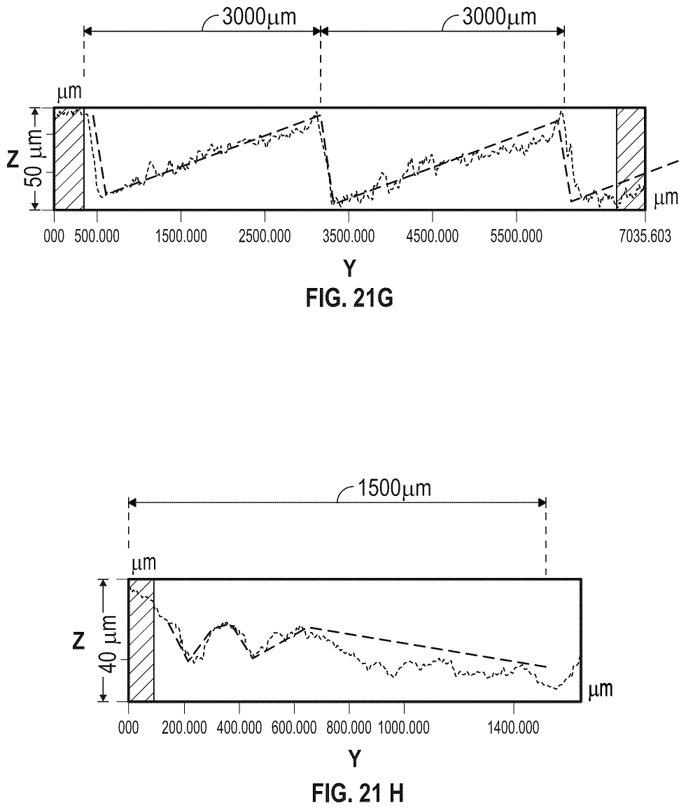

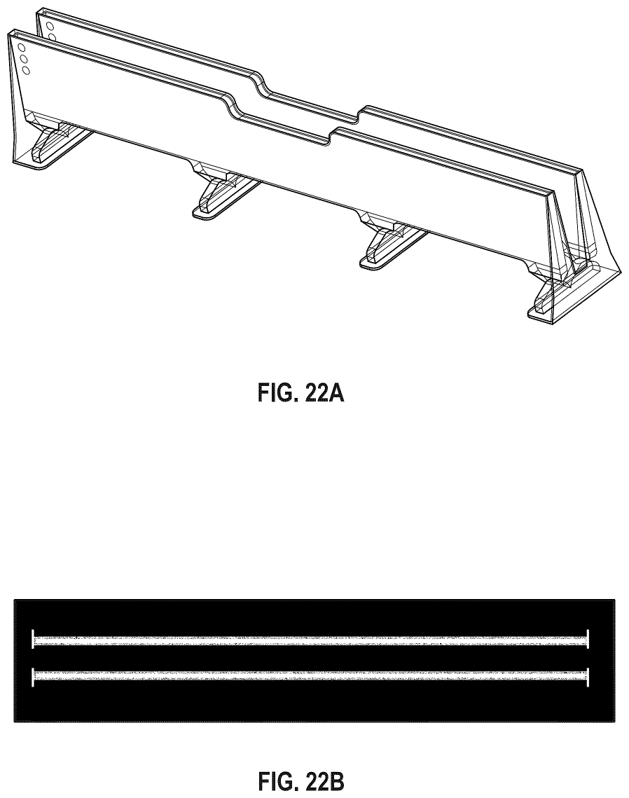

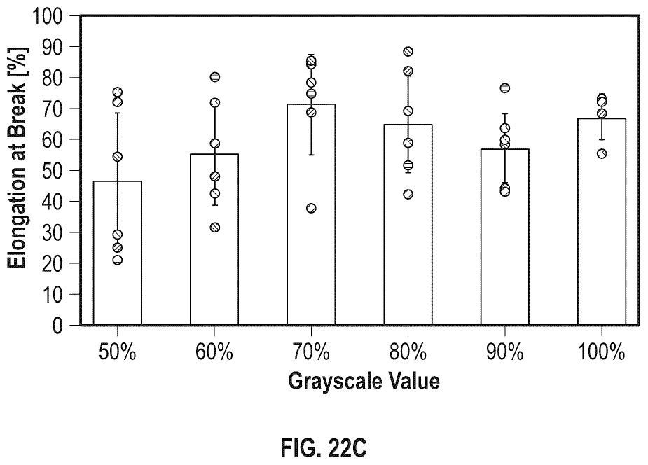

FIG. 22A illustrates a coupon design, and FIG. 22B illustrates slices of the coupon generated using stochastic discretization. Stochastic discretization was performed on the coupon volume using grayscale values ranging from 50% to 100%.

FIG. 22C is a graph illustrating tensile testing results of coupons fabricated based on stochastic object slices. As shown in FIG. 22C, coupons with intermediate grayscale values (70%-80% grayscale values) surprisingly outperformed coupons with 50% grayscale values and coupons with 100% grayscale values. Without wishing to be bound by theory, it is hypothesized that coupons with intermediate grayscale values allowed for enhanced diffusion of lower molecular weight components within the material, resulting in superior mechanical properties.

### Example 3: Stochastic Slicing with Volumetric Ratio Control—A Method for Enhanced Geometric Accuracy

This example describes an algorithm for generating object slices via stochastic discretization (“stochastic slicing.”) In advanced 3D printing processes, the ability to precisely control the exposure of light to a photosensitive material can be crucial for achieving high-resolution, accurate geometries. Traditional 3D printers often operate with a limited number of discrete light levels, which can lead to quantization errors and geometric inaccuracies in the printed object. To address this limitation, a stochastic slicing method is proposed that leverage the volumetric ratio of each voxel to control the light intensity.

### Methodology

Volumetric Ratio to Light Intensity Mapping: Given a voxel with a volumetric ratio V(x, y, z), which represents the proportion of the voxel filled with the solid part of the material, this ratio is mapped to a corresponding light intensity I_{V}(V). The function I_{V}(V) is generally nonlinear but follows these boundary conditions:
I_{V}(0)=0 (no material, no light)
I_{V} (1)=1 (fully filled voxel, maximum light intensity)
   This mapping allows the exposure level to be controlled according to the voxel's solid content, thereby ensuring that the light intensity is proportional to the desired material distribution.

Stochastic Slicing Process: Given n discrete light levels L₀, L₁, . . . , Lₙ₋₁, the stochastic slicing process involves the following steps:
1. Intensity Calculation: For each voxel, compute the light intensity I(x, y, z) using the volumetric ratio:

$$I ( x , y , z ) = {I}_{V} ( V ( x , y , z ) )$$

2. Identify the interval [Lᵢ, Lᵢ₊₁] where Lᵢ≤I(x, y, z)<Lᵢ₊₁.
3. Probability Calculation: Calculate the probability p of printing at the higher level Lᵢ₊₁ as:

$$p = \frac{I ( x , y , z ) - {L}_{i}}{{L}_{i + 1} - {L}_{i}}$$

The probability of printing at the lower level Lᵢ is 1−p.
4. Stochastic Decision: Generate a random number r uniformly distributed between 0 and 1:
If r<p, print at level Lᵢ₊₁.
If r≥p, print at level Lᵢ.

This stochastic rounding method ensures that, on average, the printed light intensity closely approximates the desired intensity I(x, y, z), allowing for finer control over the printed geometry despite the limited number of available light levels.

Advantages of the method may include:
1. Enhanced Geometric Accuracy: The stochastic slicing method allows for a finer approximation of the desired light intensity, leading to higher accuracy in the geometry of the printed object. By probabilistically combining discrete light levels, the method achieves a “micro-stepping” effect, similar to the increased resolution obtained in stepper motors.
2. Reduction of Quantization Error: The method reduces quantization error by distributing the intensity error over multiple voxels, rather than imposing a hard threshold that could lead to significant deviations from the desired geometry.
3. Improved Surface Quality: By allowing smoother transitions between light levels, the stochastic approach reduces visible artifacts and stair-stepping effects on the surface of the printed object, leading to better surface quality.
4. Flexibility with Nonlinear Material Responses: The method is flexible and can be adapted to various materials with nonlinear responses, as it relies on an experimentally determined mapping I_{V} (V), making it suitable for a wide range of applications.

### Mathematical Analysis

Expected Value: The expected light intensity for a voxel with a given volumetric ratio V(x, y, z) is calculated as:

$$𝔼 [ P ( x , y , z ) ] = p \cdot {L}_{i + 1} + ( 1 - p ) \cdot {L}_{i} = I ( x , y , z )$$

This ensures that the average printed intensity matches the desired intensity across multiple printings.

Variance: The variance of the light intensity at a given voxel is a measure of the deviation from the expected value, given by:

$$Var ( P ( x , y , z ) ) = p \cdot {( {L}_{i + 1} - I ( x , y , z ) )}^{2} + ( 1 - p ) \cdot {( {L}_{i} - I ( x , y , z ) )}^{2}$$

Since p is directly proportional to the difference between the desired intensity and the lower level, the variance provides insight into the reliability of the printed intensity. Lower variance indicates more consistent and accurate results.

Error Analysis: The error introduced by the stochastic process can be analyzed by comparing the printed light intensity's expected value to the original target intensity. By distributing this error across many voxels, the method minimizes the impact on the overall geometry.

### Special Cases

Binary Light Intensity (n=2): In the case where the printer has only two light levels, typically 0 (off) and 1 (on), the stochastic slicing process simplifies:
The light intensity function becomes a binary threshold: I(x, y, z)=1 if V(x, y, z)≥0.5, otherwise I(x, y, z)=0.
The probability p of printing at level 1 is directly the volumetric ratio V(x, y, z).
The stochastic rounding decision becomes:
   Print at level 1 (on) with probability V(x, y, z).
   Print at level 0 (off) with probability 1−V(x, y, z).
      This approach reduces the harsh quantization typically seen in binary systems by smoothing out the transition between on and off states, effectively achieving a more accurate representation of the desired geometry.

2-Bit Light Intensity (n=4): For a 2-bit system with four light levels

$${L}_{0} = 0 , {L}_{1} = \frac{1}{3} , {L}_{2} = \frac{2}{3} ,$$

### and L₃=1:

The light intensity is calculated as before using the function I_{V}(V).
Depending on which interval I(x, y, z) falls into, the stochastic rounding method applies:
   If I(x, y, z)∈[Lᵢ, Lᵢ₊₁], calculate p as:

$$p = \frac{I ( x , y , z ) - {L}_{i}}{{L}_{i + 1} - {L}_{i}}$$

Make the decision:
   Print at level Lᵢ₊₁ with probability p.
   Print at level Lᵢ with probability 1−p.
      This system allows for finer control over the light levels than the binary case, improving the accuracy of the printed geometry by offering more granularity in light intensity.

Overall, the stochastic slicing method with volumetric ratio control offers a powerful approach to improving geometric accuracy in 3D printing processes with limited light level controls. By leveraging probabilistic methods to finely control the light intensity, this technique ensures that the printed objects achieve the desired material distribution and geometric fidelity, even in the presence of hardware limitations. The mathematical analysis of expected value and variance further supports the effectiveness of this method in achieving high-quality prints, with special cases like binary and 2-bit light intensity demonstrating its versatility across different hardware configurations.

### Example 4: Stochastic Generation of 2-Bit Grayscale Slices from 8-Bit Grayscale Slices

This example describes a method for stochastic generation of 2-bit grayscale slices (4 grayscale levels) from 8-bit grayscale slices (255 grayscale levels).

The goal of the method is: for each pixel I(x, y) in the 8-bit grayscale slice, assign a quantized 2-bit level Q(x, y)∈L, such that the expected value of the 2-bit pixel approximates the value of the 8-bit pixel:

$$E [ Q ( x , y ) ] \approx I ( x , y )$$

The method can begin with normalizing the pixel intensity in the 8-bit grayscale slice to a value within a range from 0 to 1:

$$i = \frac{I ( x , y )}{255} ∈ [ 0 , 1 ]$$

Subsequently, the bounding quantization levels for converting from 8-bit to 2-bitgrayscale can be determined. Specifically, the quantization levels can be bₖ=k/3 for k∈{0, 1, 2, 3}. A value l can be determined such that bₗ≤i≤bₗ₊₁.

The probability of rounding up to the next quantization level can be determined using

$$p = \frac{i - {b}_{l}}{{b}_{l + 1} - {b}_{l}} = 3 ( i - {b}_{l} )$$

To assign the 2-bit grayscale value, a random value r can be assigned from a random distribution within a range from 0 to 1. Values can then be assigned as follows:

$$\begin{matrix}{b}^{\sim} = {b}_{l} if r \geq p \\ {b}^{\sim} = {b}_{l + 1} if r < p\end{matrix}$$

The expected value for each 2-bit grayscale pixel is

$$E [ Q ( x , y ) ] = ( 1 - p ) \times {b}_{l} \times 255 + p \times {b}_{l + 1} \times 255 = i \times 255 = I ( x , y )$$

Accordingly, the 2-bit grayscale slices generated using this method can provide an approximation of the original 8-bit grayscale slice.

### Additional Examples

The following examples are included to further describe some aspects of the present technology, and should not be used to limit the scope of the technology.

Clause 1. A method comprising:
receiving a 3D digital representation of an object;
generating a plurality of grayscale slices corresponding to a plurality of 2D cross-sections of the 3D digital representation, wherein each grayscale slice comprises a plurality of grayscale units;
generating a plurality of discretized slices based on the plurality of grayscale slices, wherein each discretized slice comprises a plurality of discretized units, and wherein each discretized unit is generated by applying a discretizing function to a corresponding grayscale unit of a corresponding grayscale slice; and
outputting instructions for fabricating the object via an additive manufacturing process based on the plurality of discretized slices.

Clause 2. The method of Clause 1, wherein the 3D digital representation is in a higher resolution than the plurality of grayscale slices and the plurality of discretized slices.

Clause 3. The method of Clause 1 or 2, wherein each grayscale unit comprises a grayscale value selected from a range of grayscale values, and wherein each discretized unit comprises a binary value selected from two discrete binary values

Clause 4. The method of Clause 1 or 2, wherein each grayscale unit comprises a first grayscale value selected from a first range of grayscale values, and wherein each discretized unit comprises a second grayscale value selected from a second range of grayscale values, the second range having a lower resolution than the first range.

Clause 5. The method of Clause 4, wherein the first range of grayscale values comprises 8-bit grayscale values and the second range of grayscale values comprises 2-bit grayscale values.

Clause 6. The method of any one of Clauses 1 to 5, wherein the discretizing function comprises selecting a discretized value for each discretized unit based on a probability distribution, and wherein the probability distribution is based on a grayscale value of the corresponding grayscale unit.

Clause 7. The method of any one of Clauses 1 to 6, wherein the discretizing function is a fully stochastic function.

Clause 8. The method of any one of Clauses 1 to 6, wherein the discretizing function is a partially stochastic or non-stochastic function.

Clause 9. The method of any one of Clauses 1 to 8, wherein the discretizing function is applied to all of the discretized units of the discretized slice.

Clause 10. The method of any one of Clauses 1 to 8, wherein the discretizing function is applied to only a subset of the discretized units of the discretized slice.

Clause 11. The method of Clause 10, wherein the subset of discretized units correspond to one or more edges of the object.

Clause 12. The method of any one of Clauses 1 to 11, further comprising applying the discretizing function.

Clause 13. The method of any one of Clauses 1 to 12, wherein the plurality of grayscale slices are generated from the 3D digital representation using a grayscaling function.

Clause 14. The method of any one of Clauses 1 to 13, wherein the additive manufacturing process comprises applying energy to a precursor material to form the object in a layer-by-layer manner, and wherein the energy applied to form each layer of the object is based on one or more discretized slices of the plurality of discretized slices.

Clause 15. The method of Clause 14, wherein the plurality of discretized slices comprises:
a first discretized slice representing a first energy distribution for forming a first layer of the object, and
a second discretized slice representing a second energy distribution for forming a second layer of the object.

Clause 16. The method of Clause 14 or 15, wherein the plurality of discretized slices comprises:
a first discretized slice representing a first energy distribution to be applied at a first time for forming a layer of the object, and
a second discretized slice representing a second energy distribution to be applied at a second time for forming the layer of the object.

Clause 17. The method of any one of Clauses 14 to 16, wherein at least some of the second discretized slices represent different energy distributions to be applied at different times to the same spatial location in the object.

Clause 18. The method of any one of Clauses 14 to 17, wherein the energy is applied by an energy source, and a size of the discretized units is smaller than an optical resolution of the energy source.

Clause 19. The method of any one of Clauses 14 to 18, wherein the precursor material comprises a curable resin.

Clause 20. The method of any one of Clauses 1 to 19, wherein the additive manufacturing process comprises one or more of the following: digital light processing, stereolithography, selective laser sintering, inkjet printing, binder jetting, continuous liquid interface production, two-photon induced photopolymerization, or volumetric additive manufacturing.

Clause 21. The method of any one of Clauses 1 to 20, further comprising fabricating the object via the additive manufacturing process.

Clause 22. The method of any one of Clauses 1 to 21, wherein the object comprises a dental appliance.

Clause 23. A system comprising:
one or more processors; and
a memory operably coupled to the one or more processors and storing instructions that, when executed by the one or more processors, cause the system to perform operations comprising:
   receiving a 3D digital representation of an object;
   generating a plurality of grayscale slices corresponding to a plurality of 2D cross-sections of the 3D digital representation, wherein each grayscale slice comprises a plurality of grayscale units;
   generating a plurality of discretized slices based on the plurality of grayscale slices, wherein each discretized slice comprises a plurality of discretized units, and wherein each discretized unit is generated by applying a discretizing function to a corresponding grayscale unit of a corresponding grayscale slice; and
   outputting instructions for fabricating the object via an additive manufacturing process based on the plurality of discretized slices.

Clause 24. The system of Clause 23, wherein the 3D digital representation is in a higher resolution than the plurality of grayscale slices and the plurality of discretized slices.

Clause 25. The system of Clause 23 or 24, wherein each grayscale unit comprises a grayscale value selected from a range of grayscale values, and wherein each discretized unit comprises a binary value selected from two discrete binary values

Clause 26. The system of Clause 23 or 24, wherein each grayscale unit comprises a first grayscale value selected from a first range of grayscale values, and wherein each discretized unit comprises a second grayscale value selected from a second range of grayscale values, the second range having a lower resolution than the first range.

Clause 27. The system of Clause 26, wherein the first range of grayscale values comprises 8-bit grayscale values and the second range of grayscale values comprises 2-bit grayscale values.

Clause 28. The system of any one of Clauses 23 to 27, wherein the discretizing function comprises selecting a discretized value for each discretized unit based on a probability distribution, and wherein the probability distribution is based on a grayscale value of the corresponding grayscale unit.

Clause 29. The system of any one of Clauses 23 to 28, wherein the discretizing function is a fully stochastic function.

Clause 30. The system of any one of Clauses 23 to 28, wherein the discretizing function is a partially stochastic or non-stochastic function.

Clause 31. The system of any one of Clauses 23 to 30, wherein the discretizing function is applied to all of the discretized units of the discretized slice.

Clause 32. The system of any one of Clauses 23 to 30, wherein the discretizing function is applied to only a subset of the discretized units of the discretized slice.

Clause 33. The system of Clause 32, wherein the subset of discretized units correspond to one or more edges of the object.

Clause 34. The system of any one of Clauses 23 to 33, wherein the operations further comprise applying the discretizing function.

Clause 35. The system of any one of Clauses 23 to 34, wherein the plurality of grayscale slices are generated from the 3D digital representation using a grayscaling function.

Clause 36. The system of any one of Clauses 23 to 35, wherein the additive manufacturing process comprises applying energy to a precursor material to form the object in a layer-by-layer manner, and wherein the energy applied to form each layer of the object is based on one or more discretized slices of the plurality of discretized slices.

Clause 37. The system of Clause 36, wherein the plurality of discretized slices comprises:
a first discretized slice representing a first energy distribution for forming a first layer of the object, and
a second discretized slice representing a second energy distribution for forming a second layer of the object.

Clause 38. The system of Clause 36 or 37, wherein the plurality of discretized slices comprises:
a first discretized slice representing a first energy distribution to be applied at a first time for forming a layer of the object, and
a second discretized slice representing a second energy distribution to be applied at a second time for forming the layer of the object.

Clause 39. The system of any one of Clauses 36 to 38, wherein at least some of the second discretized slices represent different energy distributions to be applied at different times to the same spatial location in the object.

Clause 40. The system of any one of Clauses 36 to 39, wherein the energy is applied by an energy source, and a size of the discretized units is smaller than an optical resolution of the energy source.

Clause 41. The system of any one of Clauses 36 to 40, wherein the precursor material comprises a curable resin.

Clause 42. The system of any one of Clauses 23 to 41 wherein the additive manufacturing process comprises one or more of the following: digital light processing, stereolithography, selective laser sintering, inkjet printing, binder jetting, continuous liquid interface production, two-photon induced photopolymerization, or volumetric additive manufacturing.

Clause 43. The system of any one of Clauses 23 to 42, wherein the operations further comprise fabricating the object via the additive manufacturing process.

Clause 44. The system of any one of Clauses 23 to 43, wherein the object comprises a dental appliance.

Clause 45. A non-transitory computer-readable storage medium comprising instructions that, when executed by one or more processors of a computing system, cause the computing system to perform operations comprising the method of any one of Clauses 1 to 22.

Clause 46. A method comprising:
receiving a 3D digital representation of an object;
generating a plurality of grayscale slices corresponding to a plurality of 2D cross-sections of the 3D digital representation, wherein each grayscale slice comprises a plurality of grayscale units;
generating a plurality of binary slices based on the plurality of grayscale slices, wherein each binary slice comprises a plurality of binary units, and wherein each binary unit is generated by applying a binarizing function to a corresponding grayscale unit of a corresponding grayscale slice; and
outputting instructions for fabricating the object via an additive manufacturing process based on the plurality of binary slices.

Clause 47. The method of Clause 46, wherein the 3D digital representation is in a higher resolution than the plurality of grayscale slices and the plurality of binary slices.

Clause 48. The method of Clause 46 or 47, wherein each grayscale unit comprises a grayscale value selected from a continuous range of grayscale values.

Clause 49. The method of any one of Clauses 46 to 48, wherein each binary unit comprises a binary value selected from two discrete binary values.

Clause 50. The method of any one of Clauses 46 to 49, wherein the binarizing function comprises selecting a binary value for each binary unit based on a probability distribution, and wherein the probability distribution is based on a grayscale value of the corresponding grayscale unit.

Clause 51. The method of any one of Clauses 46 to 50, wherein the binarizing function is a fully stochastic function.

Clause 52. The method of any one of Clauses 46 to 51, wherein the binarizing function is a partially stochastic or non-stochastic function.

Clause 53. The method of any one of Clauses 46 to 51, wherein the binarizing function is applied to all of the binary units of the binary slice.

Clause 54. The method of any one of Clauses 46 to 53, wherein the binarizing function is applied to only a subset of the binary units of the binary slice.

Clause 55. The method of Clause 54, wherein the subset of binary units correspond to one or more edges of the object.

Clause 56. The method of any one of Clauses 46 to 55, further comprising applying the binarizing function.

Clause 57. The method of any one of Clauses 46 to 56, wherein the plurality of grayscale slices are generated from the 3D digital representation using a grayscaling function.

Clause 58. The method of any one of Clauses 46 to 57, wherein the additive manufacturing process comprises applying energy to a precursor material to form the object in a layer-by-layer manner, and wherein the energy applied to form each layer of the object is based on one or more binary slices of the plurality of binary slices.

Clause 59. The method of Clause 58, wherein the plurality of binary slices comprises:
a first binary slice representing a first energy distribution for forming a first layer of the object, and
a second binary slice representing a second energy distribution for forming a second layer of the object.

Clause 60. The method of Clause 58 or 59, wherein the plurality of binary slices comprises:
a first binary slice representing a first energy distribution to be applied at a first time for forming a layer of the object, and
a second binary slice representing a second energy distribution to be applied at a second time for forming the layer of the object.

Clause 61. The method of any one of Clauses 58 to 60, wherein at least some of the second slices represent different energy distributions to be applied at different times to the same spatial location in the object.

Clause 62. The method of any one of Clauses 58 to 61, wherein the energy is applied by an energy source, and a size of the binary units is smaller than an optical resolution of the energy source.

Clause 63. The method of any one of Clauses 58 to 62, wherein the precursor material comprises a curable resin.

Clause 64. The method of any one of Clauses 46 to 63, wherein the additive manufacturing process comprises one or more of the following: digital light processing, stereolithography, selective laser sintering, inkjet printing, binder jetting, continuous liquid interface production, two-photon induced photopolymerization, or volumetric additive manufacturing.

Clause 65. The method of any one of Clauses 46 to 64, further comprising fabricating the object via the additive manufacturing process.

Clause 66. The method of any one of Clauses 46 to 65, wherein the object comprises a dental appliance.

Clause 67. A system comprising:
one or more processors; and
a memory operably coupled to the one or more processors and storing instructions that, when executed by the one or more processors, cause the system to perform operations comprising:
   receiving a 3D digital representation of an object;
   generating a plurality of grayscale slices corresponding to a plurality of 2D cross-sections of the 3D digital representation, wherein each grayscale slice comprises a plurality of grayscale units;
   generating a plurality of binary slices based on the plurality of grayscale slices, wherein each binary slice comprises a plurality of binary units, and wherein each binary unit is generated by applying a binarizing function to a corresponding grayscale unit of a corresponding grayscale slice; and
   outputting instructions for fabricating the object via an additive manufacturing process based on the plurality of binary slices.

Clause 68. The system of Clause 67, wherein the 3D digital representation is in a higher resolution than the plurality of grayscale slices and the plurality of binary slices.

Clause 69. The system of Clause 67 or 68, wherein each grayscale unit comprises a grayscale value selected from a continuous range of grayscale values.

Clause 70. The system of any one of Clauses 67 to 69, wherein each binary unit comprises a binary value selected from two discrete binary values.

Clause 71. The system of any one of Clauses 67 to 70, wherein the binarizing function comprises selecting a binary value for each binary unit based on a probability distribution, and wherein the probability distribution is based on a grayscale value of the corresponding grayscale unit.

Clause 72. The system of any one of Clauses 67 to 71, wherein the binarizing function is a fully stochastic function.

Clause 73. The system of any one of Clauses 67 to 72, wherein the binarizing function is a partially stochastic or non-stochastic function.

Clause 74. The system of any one of Clauses 67 to 72, wherein the binarizing function is applied to all of the binary units of the binary slice.

Clause 75. The system of any one of Clauses 67 to 74, wherein the binarizing function is applied to only a subset of the binary units of the binary slice.

Clause 76. The system of Clause 75, wherein the subset of binary units correspond to one or more edges of the object.

Clause 77. The system of any one of Clauses 67 to 76, wherein the operations further comprise applying the binarizing function.

Clause 78. The system of any one of Clauses 67 to 77, wherein the plurality of grayscale slices are generated from the 3D digital representation using a grayscaling function.

Clause 79. The system of any one of Clauses 67 to 78, wherein the additive manufacturing process comprises applying energy to a precursor material to form the object in a layer-by-layer manner, and wherein the energy applied to form each layer of the object is based on one or more binary slices of the plurality of binary slices.

Clause 80. The system of Clause 79, wherein the plurality of binary slices comprises:
a first binary slice representing a first energy distribution for forming a first layer of the object, and
a second binary slice representing a second energy distribution for forming a second layer of the object.

Clause 81. The system of Clause 79 or 80, wherein the plurality of binary slices comprises:
a first binary slice representing a first energy distribution to be applied at a first time for forming a layer of the object, and
a second binary slice representing a second energy distribution to be applied at a second time for forming the layer of the object.

Clause 82. The system of any one of Clauses 79 to 81, wherein at least some of the second slices represent different energy distributions to be applied at different times to the same spatial location in the object.

Clause 83. The system of any one of Clauses 79 to 82, wherein the energy is applied by an energy source, and a size of the binary units is smaller than an optical resolution of the energy source.

Clause 84. The system of any one of Clauses 79 to 83, wherein the precursor material comprises a curable resin.

Clause 85. The system of any one of Clauses 67 to 84, wherein the additive manufacturing process comprises one or more of the following: digital light processing, stereolithography, selective laser sintering, inkjet printing, binder jetting, continuous liquid interface production, two-photon induced photopolymerization, or volumetric additive manufacturing.

Clause 86. The system of any one of Clauses 67 to 85, further comprising a printer assembly configured to fabricate the object via the additive manufacturing process.

Clause 87. The system of Clause 86, wherein the printer assembly comprises:
a source of a precursor material, and
an energy source configured to apply energy to the precursor material according to the instructions.

Clause 88. The system of any one of Clauses 67 to 87, wherein the object comprises a dental appliance.

Clause 89. A non-transitory computer-readable storage medium comprising instructions that, when executed by one or more processors of a computing system, cause the computing system to perform operations comprising the method of any one of Clauses 46 to 66.

### CONCLUSION

Although many of the embodiments are described above with respect to systems, devices, and methods for manufacturing dental appliances, the technology is applicable to other applications and/or other approaches, such as manufacturing of other medical devices or other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-22C.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a 3D digital representation of an object;
generating a plurality of grayscale slices corresponding to a plurality of 2D cross-sections of the 3D digital representation, wherein each grayscale slice comprises a plurality of grayscale units;
generating a plurality of discretized slices based on the plurality of grayscale slices, wherein each discretized slice comprises a plurality of discretized units, and wherein each discretized unit is generated by applying a discretizing function to a corresponding grayscale unit of a corresponding grayscale slice; and
outputting instructions for fabricating the object via an additive manufacturing process based on the plurality of discretized slices.

2. The method of claim 1, wherein each grayscale unit comprises a grayscale value selected from a range of grayscale values, and wherein each discretized unit comprises a binary value selected from two discrete binary values.

3. The method of claim 1, wherein each grayscale unit comprises a first grayscale value selected from a first range of grayscale values, and wherein each discretized unit comprises a second grayscale value selected from a second range of grayscale values, the second range having a lower resolution than the first range.

4. The method of claim 1, wherein the discretizing function comprises selecting a discretized value for each discretized unit based on a probability distribution, and wherein the probability distribution is based on a grayscale value of the corresponding grayscale unit.

5. The method of claim 1, wherein the discretizing function is applied to all of the discretized units of the discretized slice.

6. The method of claim 1, wherein the discretizing function is applied to only a subset of the discretized units of the discretized slice corresponding to one or more edges of the object.

7. The method of claim 1, wherein the additive manufacturing process comprises applying energy to a precursor material to form the object in a layer-by-layer manner, and wherein the energy applied to form each layer of the object is based on one or more discretized slices of the plurality of discretized slices.

8. The method of claim 7, wherein the plurality of discretized slices comprises:
a first discretized slice representing a first energy distribution for forming a first layer of the object, and
a second discretized slice representing a second energy distribution for forming a second layer of the object.

9. The method of claim 7, wherein the plurality of discretized slices comprises:
a first discretized slice representing a first energy distribution to be applied at a first time for forming a layer of the object, and
a second discretized slice representing a second energy distribution to be applied at a second time for forming the layer of the object.

10. The method of claim 1, further comprising fabricating the object via the additive manufacturing process.

11. A system comprising:
one or more processors; and
a memory operably coupled to the one or more processors and storing instructions that, when executed by the one or more processors, cause the system to perform operations comprising:
receiving a 3D digital representation of an object;
generating a plurality of grayscale slices corresponding to a plurality of 2D cross-sections of the 3D digital representation, wherein each grayscale slice comprises a plurality of grayscale units;
generating a plurality of discretized slices based on the plurality of grayscale slices, wherein each discretized slice comprises a plurality of discretized units, and wherein each discretized unit is generated by applying a discretizing function to a corresponding grayscale unit of a corresponding grayscale slice; and
outputting instructions for fabricating the object via an additive manufacturing process based on the plurality of discretized slices.

12. The system of claim 11, wherein each grayscale unit comprises a grayscale value selected from a range of grayscale values, and wherein each discretized unit comprises a binary value selected from two discrete binary values.

13. The system of claim 11, wherein each grayscale unit comprises a first grayscale value selected from a first range of grayscale values, and wherein each discretized unit comprises a second grayscale value selected from a second range of grayscale values, the second range having a lower resolution than the first range.

14. The system of claim 11, wherein the discretizing function comprises selecting a discretized value for each discretized unit based on a probability distribution, and wherein the probability distribution is based on a grayscale value of the corresponding grayscale unit.

15. The system of claim 11, wherein the discretizing function is applied to all of the discretized units of the discretized slice.

16. The system of claim 11, wherein the discretizing function is applied to only a subset of the discretized units of the discretized slice corresponding to one or more edges of the object.

17. The system of claim 11, wherein the additive manufacturing process comprises applying energy to a precursor material to form the object in a layer-by-layer manner, and wherein the energy applied to form each layer of the object is based on one or more discretized slices of the plurality of discretized slices.

18. The system of claim 17, wherein the plurality of discretized slices comprises:
a first discretized slice representing a first energy distribution for forming a first layer of the object, and
a second discretized slice representing a second energy distribution for forming a second layer of the object.

19. The system of claim 17, wherein the plurality of discretized slices comprises:
a first discretized slice representing a first energy distribution to be applied at a first time for forming a layer of the object, and
a second discretized slice representing a second energy distribution to be applied at a second time for forming the layer of the object.

20. The system of claim 11, wherein the operations further comprise fabricating the object via the additive manufacturing process.
